(19) United States
(12) Patent Application Publication
(10) Pub. No.: US 2026/0283883 A1
(43) Pub. Date: Sep. 24, 2026

(54) INFLATABLE MATTRESS AND CONTROL THEREOF

(71) Applicant: Stryker Corporation, Portage, MI (US)

(72) Inventors: Richard A. Derenne, Portage, MI (US); Tashana J. Flewwellin, Portage, MI (US); James K. Galer, Byron Center, MI (US); Kurosh Nahavandi, Portage, MI (US); Nicholas D. Koch, Battle Creek, MI (US); Brian Cheadle, Kalamazoo, MI (US); Ryan Ariel Alvarez, Kalamazoo, MI (US)

(21) Appl. No.: 19/471,984

(22) PCT Filed: May 20, 2024
(86) PCT No.: PCT/US2024/030233

§ 371 Date: Oct. 2, 2025

Related U.S. Application Data
(60) Provisional application No. 63/468,142, filed on May 22, 2023.

(51) Int. Cl. A61G 7/057; A61G 7/00

(52) U.S. Cl. CPC A61G 7/05776; A61G 7/001; A61G 2203/34

(57) ABSTRACT

A patient support system is provided capable of forming a gap (e.g., a channel) between a target region of a patient and a support surface on which the patient is supported. The gap may be provided by selectively lowering a region of the patient support that is aligned with the target region of the patient.

### TECHNICAL FIELD

The present disclosure relates to mattresses used for supporting individuals thereon, and more particularly to mattresses that are used in healthcare settings and that have one or more inflatable zones.

### BACKGROUND

In health care settings, hospital acquired pressure injuries lead to 60,000 deaths per year. Hospital mattresses are used to treat and prevent pressure injuries as well as support patients positioned on beds, stretchers, cots, and the like. There are four main factors for developing pressure injuries: pressure, heat, moisture, and shear.

Hospital mattresses have various means of redistributing pressure including one or more inflatable bladders whose inflation levels can be controlled. The inflation level of the bladders may be set so as to distribute the patient's weight over as great an area as possible, or over an area large enough to reduce undesired force concentrations on the patient's body. Approximately 70% of pressure injuries occur in the sacral region about boney prominences. Current clinical guidelines call for turning a patient every two hours to redistribute pressure about the sacral region. This is known as “Q2 turning.” Acceptance criteria of Q2 turns requires clinicians to offload the sacrum and recommend turning the patient to a 30° angle. Conventional offloading is achieved by supporting adjacent regions above and below the sacrum often using pillows or wedges to create a gap directly beneath the sacral region. An adequate offload for this procedure can be verified by reaching beneath a patient to touch their sacrum to confirm no contact between the patient and lower surface. The Q2 turn is the standard of care for pressure injury prevention, however conventional products available in the market do not achieve the Q2 turn automatically for a caregiver. Conventional products exist that either 1) assist in positioning a patient in the Q2 turn position or 2) automatically turn a patient without satisfying the requirements of maintaining a Q2 turn. The Q2 turn position also provides ambient air access to the sacral region allowing heat and moisture dissipation.

Conventional mattresses used in healthcare settings often accumulate moisture between the mattress and the patient which increases the skin's coefficient of friction potentially leading to a pressure injury. Efforts have been made to address these concerns, such as by incorporation of microclimate management features such as low air loss systems. However, despite such efforts, moisture accumulation and pressure injury remain a concern. Likewise, moisture accumulation and pressure injuries with the patient laying on the mattress can be obstructed from view or inspection. Conventionally, the patient can be moved periodically to dissipate moisture and heat accumulation; however, such inspections are time consuming, disruptive to patient care, and pose patient handling concerns.

Nursing is a laborious profession in the United States due to the cumulative muscular-skeletal strain resulting from patient repositioning activities. Turning patients constitutes one of several strain-related activities nurses perform. Products exist that assist caregivers in these care activities; however, there is still exertion by the caregiver without an available automated solution. Patient turning is performed for more than pressure redistribution and microclimate management pressure injury prevention care. Skin checks represent standard of care for pressure injury diagnosis.

Caregivers rotate a supine patient on their side to inspect their rear skin condition as part of pressure injury skin checks. Inspection can involve separation of skin folds and blanching the skin to assess reperfusion. Rotating allows caregivers sufficient access to perform these assessment steps. However, not all patients can tolerate turning.

Hemodynamically unstable patients may desaturate when being rotated causing care staff concern to move them. This is an intentional tradeoff favoring the cardiac concern over the skin as one example of prioritizing other vital organ systems. Providing a means pressure redistribution, microclimate management, and skin checks for patients in the supine position without reposition would allow a caregiver to balance traditionally competing priorities.

Other devices within the confines of a hospital mattress provide solutions to adjacent problems that the mattresses do not address. A bed sheet provides a hygienic layer between the patient and mattress top cover that can be laundered between patient uses. Repositioning devices decrease the force required to boost, laterally transfer, and turn patients. Absorbent pads (or chux) remove and collect moisture excreted from the patient and often lie in the closest proximity to a patient. Patient gowns promote patient dignity but allow sufficient access for care activities. Specialty mattresses intended for pressure injury prevention often do not take these adjacent layers into consideration when evaluating overall pressure injury performance leaving ambiguity for caregivers to determine the cumulative effects on patient care.

### SUMMARY OF THE DESCRIPTION

In general, one innovative aspect of the subject matter described herein can be provided in a patient support system for a patient support apparatus including a deck with one or more deck sections. The patient support system may include a patient support that can be supported on said deck. The patient support may include first and second inflatable bladders. The first inflatable bladder may be associated with a first support surface region of the patient support, and the second inflatable bladder may be associated with a second support surface region of the patient support. The first and second inflatable bladders may be adjacent to each other and operable to contact and cooperatively support a patient on the first and second support surface regions.

The patient support system may include a control system configured to direct an inflation level for the first and second inflatable bladders. The control system may be operable to reduce an inflation level of the second inflatable bladder relative to the first inflatable bladder to selectively lower the second support surface region relative to the first support surface region such that a gap is provided between the second support surface region and the patient.

The foregoing and other aspects can each optionally include one or more of the following features, alone or in combination. In particular, one aspect includes all the following features in combination.

In some aspects, the reduction in inflation level of the second inflatable bladder may be reduced by deflation of the second inflatable bladder.

In some aspects, deflation may be provided by forming a vacuum with respect to the second inflatable bladder.

In some aspects, the control system may be operable to direct an inflation level of the second inflatable bladder as part of a zone of a plurality of bladders associated with the second inflatable bladder.

In some aspects, the patient support may include a third inflatable bladder associated with a third support surface region of the patient support. The third inflatable bladder may be disposed on a side of the second inflatable bladder opposite the first inflatable bladder.

In some aspects, the control system may be configured to direct an inflation level of the second inflatable bladder to selectively lower the second support surface region relative to both the first and third support surface regions to such that the gap is provided between the second support surface region and the patient and between the first and third support surface regions.

In some aspects, the first and third support surface regions may support and contact the patient, and where the gap may provide a channel between the first and third support surface regions.

In some aspects, the channel may provide a fluid path for ambient air to flow between the second support surface region and the patient.

In some aspects, the third inflatable bladder may be adjacent to the second inflatable bladder such that the second inflatable bladder is sandwiched between the first and third inflatable bladders.

In some aspects, an area of the patient supportable by the second support surface region is visible for inspection via the gap.

In some aspects, the gap provides physical access for inspection of the patient from a side of the patient support.

In some aspects, the gap may be sufficiently large to offload pressure but sufficiently small to prevent bottoming out of the patient with respect to the support deck.

In some aspects, the patient support may be sufficiently large to allow ambient air access but sufficiently small to prevent bottoming out of the patient with respect to the support deck.

In some aspects, the patient support may include an uppermost layer provided between first and second inflatable bladders and the patient. The uppermost layer may be operatively coupled to the second inflatable bladder and may provide the second support surface region for supporting the patient thereon. The second support surface region of the uppermost layer may lower to provide the gap in response to a reduction in the inflation level of the second inflatable bladder relative to the first inflatable bladder.

In some aspects, the uppermost layer may be attached to the second inflatable bladder.

In some aspects, one or more intermediate layers may be provided between the uppermost layer and the second inflatable bladder, and where the one or more intermediate layers may move with the uppermost layer.

In some aspects, a vacuum may be formed with respect to the uppermost layer and the bladders to facilitate moving the uppermost layer with the second inflatable bladder.

In some aspects, the gap may provide an area of zero pressure with respect to the patient and the second support surface region of the patient.

In some aspects, an interface pressure sensor may be provided between the patient and the first and second support surface regions. The interface pressure sensor may be configured to provide interface pressure sensor information pertaining to an interface pressure respectively between the patient and the first and second support surface regions.

In some aspects, the control system may be configured to direct the inflation level for the first and second inflatable bladders based on the interface pressure sensor information.

In some aspects, the control system may be configured to determine a position of the patient on the patient support based on the pressure sensor information.

In some aspects, the control system may be configured to direct the inflation levels of the first and second inflatable bladders based on the determined position of the patient on the patient support.

In some aspects, the first inflatable bladder may be controlled according to an alternating low pressure therapy process while the second inflatable bladder is offloaded relative to the patient.

In some aspects, the first inflatable bladder may be controlled according to an active pressure redistribution process while the second inflatable bladder is offloaded relative to the patient.

In some aspects, the control system may be operable to receive a manual selection from a caregiver to offload the second support surface region relative to the patient.

In some aspects, a user interface may be operable to receive the manual selection from the caregiver.

In some aspects, the control system may be configured to selectively offload the second support surface region relative to the first support surface region, while disabling the first inflatable bladder from offloading the first support surface region.

In some aspects, the control system may be configured to sequentially offload the first and second support surface regions, where the control system may be configured to direct the inflation level of the second inflatable bladder to offload the second support surface region relative to the patient for a first duration, and where the control system may be configured to direct, after the first duration, the inflation level of the second inflatable bladder to support the patient on the second support surface region and to direct the inflation level of the first inflatable bladder to offload the first support surface region relative to the patient for a second duration.

In some aspects, a user interface may be operable to display information to the caregiver, wherein said control system is operable to direct the user interface to display a heat map based on an amount of time between a threshold time and the second support surface region being lowered for offloading and raised back to support the patient and an amount of time between the threshold time and the first support surface region being lowered for offloading and raised back to support the patient.

In some aspects, the control system may be operable to determine a sequence of offloading for multiple inflatable bladders based on an adjacency relationship among the multiple inflatable bladders.

In general, one innovative aspect of the subject matter described herein can be provided in a patient support system for a patient support apparatus including a deck with one or more deck sections. The patient support system may include a patient support that can be supported on the deck. The patient support may include a first support surface region and a second support surface region. The first and second surface regions may be adjacent to each other and operable to contact and cooperatively support a patient.

The patient support system may include a control system configured to direct a height of the first and second support surface regions. The control system may be operable to selectively lower the second support surface region relative to the first support surface region such that a gap is provided between the second support surface region and the patient.

The foregoing and other aspects can each optionally include one or more of the following features, alone or in combination. In particular, one aspect includes all the following features in combination.

In some aspects, the patient support system may include a turning mechanism operable to lift a lateral side of the patient relative the other lateral side of the patient. The control system may be operable to direct the turning mechanism in conjunction with lowering the height of the second support surface region.

In some aspects, the turning mechanism in conjunction with the lowered second support surface region may enable visual and/or physical inspection of a patient area.

In some aspects, the control system may be operable to direct the turning mechanism to lift the lateral side of the patient and to provide the gap to offload a region of the patient.

In some aspects, the turning mechanism may be a bladder.

In some aspects, the patient support may include first and second inflatable bladders. The first inflatable bladder may be associated with the first support surface region of the patient support, and the second inflatable bladder may be associated with a second support surface region of the patient support. The first and second inflatable bladders may be adjacent to each other and operable to contact and cooperatively support a patient on the first and second support surface regions.

In some aspects, the patient support may include an uppermost layer that contacts the patient. The uppermost layer may be operatively coupled to the second inflatable bladder and may provide the second support surface region for supporting the patient thereon. The second support surface region of the uppermost layer may lower to provide the gap in response to a reduction in the inflation level of the second inflatable bladder relative to the first inflatable bladder.

In some aspects, the uppermost layer may be attached to the second inflatable bladder.

In some aspects, one or more intermediate layers may be provided between the uppermost layer and second inflatable bladder, and the one or more intermediate layers may be operable to move with the uppermost layer.

In some aspects, the reduction in inflation level of the second inflatable bladder may be reduced by deflation of the second inflatable bladder.

In some aspects, the control system may be operable to direct an inflation level of the second inflatable bladder as part of a zone of a plurality of bladders associated with the second inflatable bladder.

In some aspects, the patient support may include a third inflatable bladder associated with a third support surface region of the patient support. The third inflatable bladder may be disposed on a side of the second inflatable bladder opposite the first inflatable bladder.

In some aspects, the control system may be configured to direct an inflation level of the second inflatable bladder to selectively lower the second support surface region relative to both the first and third support surface regions to such that the gap is provided between the second support surface region and the patient and between the first and third support surface regions.

In some aspects, the first and third support surface regions may support and contact the patient, and where the gap may provide a channel between the first and third support surface regions.

In some aspects, the channel may provide a fluid path for ambient air to flow between the second support surface region and the patient.

In some aspects, the third inflatable bladder may be adjacent to the second inflatable bladder such that the second inflatable bladder is sandwiched between the first and third inflatable bladders.

In some aspects, an area of the patient supportable by the second support surface region may be visible for inspection via the gap.

In some aspects, the gap may provide physical access for inspection of the patient from a side of the patient support.

In some aspects, the gap may be sufficiently large to offload pressure but sufficiently small to prevent bottoming out of the patient with respect to the support deck.

In some aspects, the gap may be sufficiently large to allow ambient access of air but narrow to prevent bottoming out of the patient with respect to the support deck.

In some aspects, the gap may provide an area of zero pressure with respect to the patient and the second support surface region of the patient.

Before the embodiments and aspects of the disclosure are explained in detail, it is to be understood that the disclosure is not limited to the details of operation or to the details of construction and the arrangement of the components set forth in the following description or illustrated in the drawings. The disclosure may be implemented in various other embodiments and aspects and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments and aspects. Unless otherwise expressly stated, the use of enumeration should not be construed as limiting one or more embodiments or aspects to any specific order or number of components. Nor should the use of enumeration be construed as excluding from the scope of an embodiment or aspect any additional steps or components that might be combined with or into the enumerated steps or components.

### DRAWINGS

FIG. 1 shows a patient support apparatus according to one aspect of the present disclosure.

FIG. 2 shows a patient support according to one aspect of the present disclosure.

FIG. 3 shows a perspective view of a patient support according to one aspect of the present disclosure.

FIG. 4 shows a partial, exploded view of the patient support of FIG. 3.

FIG. 5 depicts a control system for a patient support according to one aspect of the present disclosure.

FIG. 6 shows a representative, side view of a gap provided by a patient support according to one aspect of the present disclosure.

FIG. 7 shows a top view of the gap and patient support depicted in FIG. 6.

FIG. 8 shows a side view of a target region of a patient and a gap provided by a patient support according to one aspect of the present disclosure.

FIG. 9 shows a perspective view of a gap provided by a patient support according to one aspect of the present disclosure.

FIG. 10 shows a heat map for interface pressure of a patient supported on a patient support according to one aspect of the present disclosure.

FIG. 11 shows a plurality of inflatable bladders and a gap provided by the same according to one aspect of the present disclosure.

FIG. 12 shows a plurality of inflatable bladders according to one aspect of the present disclosure.

FIG. 13 shows a plurality of inflatable bladders according to one aspect of the present disclosure.

FIG. 14 shows a perspective view of a gap provided by a patient support according to one aspect of the prison disclosure.

FIG. 15 shows a perspective view of a gap provided by a patient support according to one aspect of the prison disclosure.

FIG. 16 shows a front view of a patient support with a turn mechanism activated.

FIG. 17 shows a front view of the patient support in FIG. 16 with a patient supported on the patient support and tilted by the turn mechanism.

FIG. 18 shows a side view of the patient support in FIG. 16 with the patient support supported on the patient support, tilted by the turn mechanism, and with an offloaded area provided by a gap.

FIG. 19 shows a heat map based on sensor feedback in one aspect.

FIG. 20 shows a top representative view of a patient support according to one aspect.

FIG. 21 shows a top representative view of a patient support according to one aspect.

FIG. 22 shows a method of operation according to one aspect.

FIG. 23 shows a top representative view of a patient support according to one aspect.

FIG. 24 shows a top representative view of a patient support according to one aspect.

FIG. 25 shows a top representative view of a patient support according to one aspect.

FIG. 26 shows a top representative view of a patient support as well as a heat map according to one aspect.

FIG. 27 shows a method of operation according to one aspect.

FIG. 28 shows a top representative view of a patient support according to one aspect.

FIG. 29 shows a top representative view of a patient support according to one aspect.

FIG. 30 shows a top representative view of a patient support according to one aspect.

FIG. 31 shows a top representative view of a patient support as well as a heat map according to one aspect.

FIG. 32 shows a top representative view of a patient support as well as a heat map according to one aspect.

FIG. 33 shows a heat map based on sensor feedback in one aspect.

FIG. 34 shows a method of operation according to one aspect.

FIG. 35 shows a top representative view of a patient support as well as a heat map according to one aspect.

FIG. 36 shows a top representative view of a patient support as well as a heat map according to one aspect.

FIG. 37 shows a method of operation according to one aspect.

FIG. 38 shows a method of operation according to one aspect.

FIG. 39 shows a top representative view of a patient support as well as a heat map according to one aspect.

FIG. 40 shows a method of operation according to one aspect.

### DESCRIPTION

A patient support system is provided capable of forming a gap (e.g., a channel) between a target region of a patient and a support surface on which the patient is supported. The gap may be provided by selectively lowering a region of the patient support that is aligned with the target region of the patient.

### I. Overview

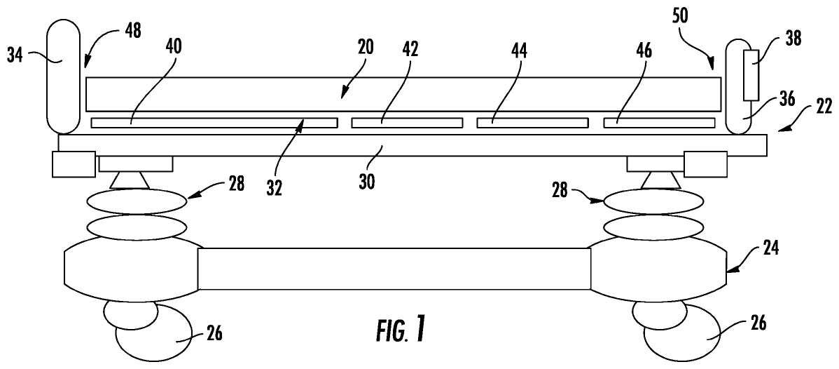

FIG. 1 illustrates a patient support 20 according to one aspect of the present disclosure. In the example of FIG. 1, the patient support 20 is a mattress. However, it will be understood that the patient support 20 may take on other manifestations, such as cushions, pads, etc. Indeed, in one aspect, the patient support 20 may be a cushion or pad for a chair, such as a wheelchair or a stationary chair. In general, the patient support 20 may be utilized wherever and whenever a patient is to be supported on a surface and it is desirable to reduce interface pressures experienced by the patient while positioned on the patient support 20.

In FIG. 1, the patient support 20 is supported on a patient support apparatus 22 that, in this particular configuration, is a bed. The patient support apparatus 22 may take on other forms besides beds, such as, but not limited to, cots, stretchers, operating tables, gurneys, and the like. The patient support apparatus 22 may be a conventional support apparatus that is commercially available and that merely provides a supporting function for the patient support 20. In other aspects, the patient support apparatus 22 may include one or more controls that are integrated therein and which are used in controlling the operation of the patient support 20, as will be discussed in greater detail herein.

As shown in FIG. 1, patient support apparatus 22 includes a base 24 having a plurality of wheels 26, a pair of elevation adjustment mechanisms 28 supported on the base 24, a frame or litter 30 supported on the elevation adjustment mechanisms 28, and a patient support deck 32 supported on the frame 30. The patient support apparatus 22 may also include a headboard 34 and a footboard 36. Either or both of the headboard 34 and the footboard 36 may be removable from the frame 30 and may include one or more electrical connectors for establishing electrical communication between electronic components on or in the footboard 36 and/or the headboard 34 and other electronic components supported on or in the frame 30. Such electrical connector(s) may include any one or more of the connectors disclosed in commonly assigned U.S. patent application Ser. No. 13/790,762, filed Mar. 8, 2013, by applicants Krishna Bhimavarapu and entitled PATIENT SUPPORT APPARATUS CONNECTORS, the disclosures of which are incorporated herein by reference in their entirety. Other types of connectors may also be used.

In one aspect, electrical connectors may be provided for establishing an electrical link between the patient support 20 and a user interface 38 that is positioned on, or integrated into, the footboard 36 or another aspect of the patient support apparatus 22. The user interface 38 may take on a variety of different forms, such as, but not limited to, a touch screen, a Liquid Crystal Display (LCD), a plurality of buttons, switches, knobs, or the like, or any combination of these components. The user interface 38 may allow a user to control the operation of the patient support 20. The electrical connection between the user interface 38 and the patient support 20 may take on different forms, including a direct electrical cable that runs from the footboard 36 to the patient support 20. As another example, the footboard 36 may include electrical connectors that electrically couple the user interface 38 to circuitry supported on the frame 30. This circuitry may be in further electrical communication with a port (not shown) to which an electrical cable from the patient support 20 may be inserted, thereby establishing an electrical link between the user interface 38 and the patient support 20. In yet another example, communication between the user interface 38 and the patient support 20 may be entirely wireless. A further example of such wireless communication is disclosed in commonly assigned U.S. patent application Ser. No. 13/802,992, filed Mar. 24, 2013, by applicants Michael Hayes et al. and entitled COMMUNICATION SYSTEMS FOR PATIENT SUPPORT APPARATUSES, the complete disclosure of which is hereby incorporated herein by reference.

The elevation adjustment mechanisms 28 are adapted to raise and lower the frame 30 with respect to the base 24. The elevation adjustment mechanisms 28 may be implemented as hydraulic actuators, electric actuators, or any other suitable device for raising and lowering the frame 30 with respect to the base 24. In FIG. 1, the elevation adjustment mechanisms 28 are depicted to be operable independently so that the orientation of the frame 30 with respect to the base 24 may also be adjusted. This may allow the patient support apparatus 22 to tilt a patient supported on the patient support 20 to either the Trendelenburg orientation, or the reverse Trendelenburg orientation.

The frame 30 may provide a structure for supporting the patient support deck 32, the headboard 34, and the footboard 36. The patient support deck 32 may provide a surface on which the patient support 20 can be positioned so that a patient may lie and/or sit thereon. The patient support deck 32 may be made of a plurality of sections, some of which may be pivotable about generally horizontal pivot axes—although it is to be understood that the patient support deck 32 may be configured differently without plurality of sections (e.g., one section). In the configuration shown in FIG. 1, the patient support deck 32 includes a head or back section 40, a seat section 42, a thigh section 44, and a foot section 46. In other configurations, the patient support deck 32 may include fewer or greater numbers of sections. The head section 40, which is also sometimes referred to as a Fowler section or back section, may be pivotable between a generally horizontal orientation (shown in FIG. 1) and a plurality of raised positions (not shown in FIG. 1). The thigh section 44 and the foot section 46 may also be pivotable about horizontal pivot axes.

The general construction of any of the base 24, the elevation adjustment mechanisms 28, the frame 30, the patient support deck 32, the headboard 34, and/or the footboard 36 may take on any known or conventional design, such as, for example, that disclosed in commonly assigned, U.S. Pat. No. 7,690,059 issued to Lemire et al., and entitled HOSPITAL BED, the complete disclosure of which is incorporated herein by reference; or that disclosed in commonly assigned U.S. Pat. publication No. 2007/0163045 filed by Becker et al. and entitled PATIENT HANDLING DEVICE INCLUDING LOCAL STATUS INDICATION, ONE-TOUCH FOWLER ANGLE ADJUSTMENT, AND POWER-ON ALARM CONFIGURATION, the complete disclosure of which is also hereby incorporated herein by reference. The construction of any of the base 24, the elevation adjustment mechanisms 28, the frame 30, the patient support deck 32, the headboard 34, and/or the footboard 36 may also take on forms different from what is disclosed in the aforementioned patent and patent publication.

In some aspects, the operation of the patient support 20 may be based at least partially upon sensor data that originates from sensors integrated into the patient support apparatus 22, while in other aspects, the patient support 20 may operate solely on sensor data originating from sensors positioned internally inside of the patient support 20. For those aspects in which the patient support 20 uses sensor data from the patient support apparatus 22, such sensor data may include angle data and/or weight data. More specifically, the patient support apparatus 22, in some aspects, may include one or more angle sensors that detect the angular orientation (with respect to horizontal) of the frame 30, as well as one or more angle sensors that detect the angular orientation (with respect to horizontal) of one or more of the sections of the support deck 32. Still further, the patient support apparatus 22, in some aspects, may include a load cell system that detects patient weight and/or a center of gravity of a patient positioned on the patient support 20. One such load cell system that may be used in patient support apparatus 22 is disclosed in commonly assigned U.S. Pat. No. 5,276,432 issued to Travis, the complete disclosure of which is incorporated herein by reference. Other load cell systems may also be used. Regardless of the specific load cell system used, the patient support apparatus 22 may communicate any one or more of patient weight, patient center of gravity, the angular orientation of the frame 30, and/or the angular orientation of one or more of the deck sections 40-46 to the patient support 20, which may use this data in manners discussed in further detail herein.

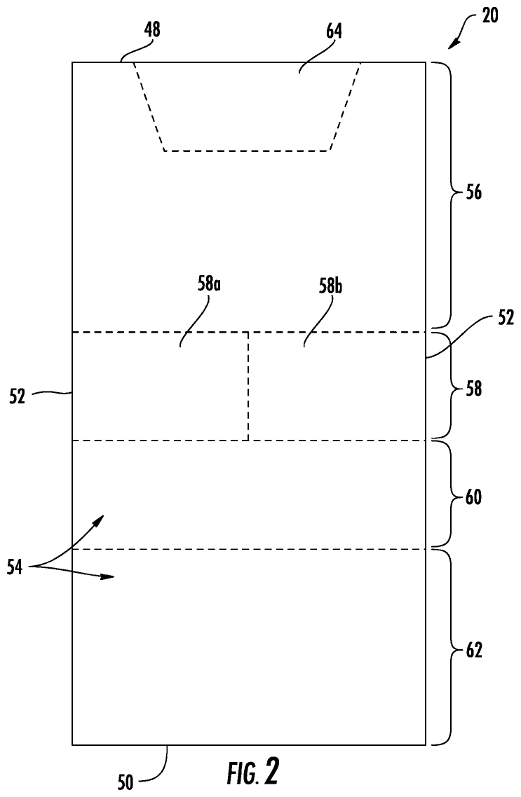

Turning to FIG. 2, the patient support 20 may further include a back zone 56, a thigh zone 60, and a foot zone 62. The back zone 56 may include a head zone or pillow zone 64. The physical boundaries of each of the zones may be modified from that shown, as well as the number of locations of each zone. In the configuration of FIG. 2, the back zone 56 is positioned such that it will generally be aligned with the head or back section 40 of the patient support apparatus 22 when the patient support 20 is positioned on the support deck 32. Similarly, the seat zone 58 will be generally aligned with the seat section 42, the thigh zone 60 will be generally aligned with the thigh section 44, and the foot zone 62 will be generally aligned with the foot section 46. Such alignment, however, is not necessary. Indeed, the patient support 20 may be used on patient support apparatuses 22 in which the support deck 32 has no individual sections, or which has a fewer or greater number than the four shown in FIG. 1.

The seat zone 58, as depicted shown in FIG. 2, is subdivided into right and left sides. That is, the seat zone 58 includes a right seat zone 58a and a left seat zone 58b. Each of the seat zones 58a and 58b define regions in which hermetically isolated bladders (also described as pods herein) may be positioned so that the inflation level corresponding to the right seat zone 58a can be controlled and/or set independently of the inflation level corresponding to the left seat zone 58b. In this manner, if a patient is lying on his or her side, or is otherwise positioned closer to one side 52 than the other, zones 58a and 58b can be set, at least in some configurations, to different inflation levels. Alternatively, the inflation levels may be set for zones 58a and 58b differently in situations where the patient is positioned more toward the middle of the patient support 20. In alternative configurations, the seat zone 58 may be a single zone that does not have separate subdivisions between the right and left side, but rather is inflatable and deflatable in a unitary manner. In still other alternative configurations, one or more of the other zones 56, 60, and/or 62 may be subdivided into left and right sub-zones, or sub-divided in still other manners.

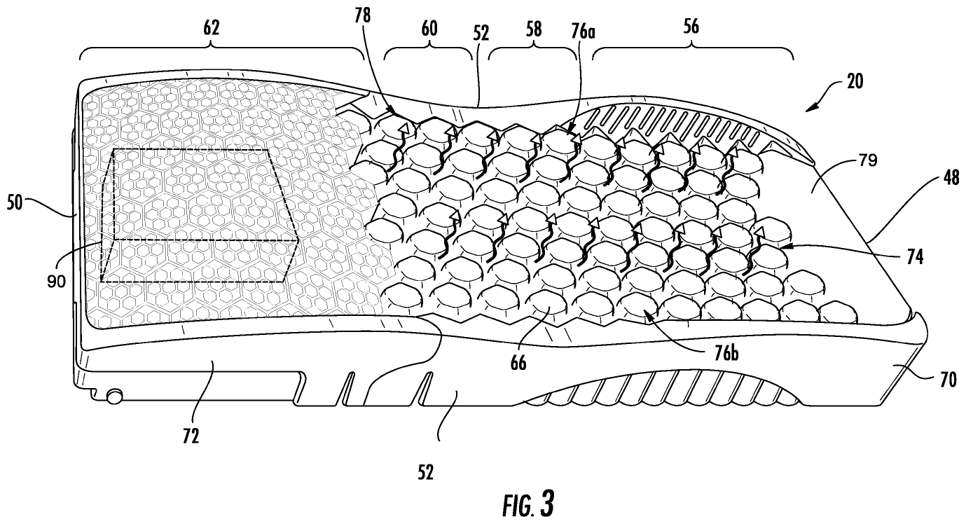

FIG. 3 shows the patient support 20 with its outer cover removed, exposing a plurality of inflatable pods 66, as well as a pillow bladder 79, a foam crib 70 that supports the pods 66, and a plurality of molded foot end cushioning 72. Foam cushioning 72 is not inflatable, but instead provides cushioned support to a patient's feet through its soft pliability. In an alternative configuration, the foam crib 70 may be absent entirely or in one or more areas of the periphery of the patient support 20. In this configuration, in place of the foam crib 70, one or more inflatable pods 66 may be provided. As an example, the one or more inflatable pods 66 may be provided at the periphery in areas where the foam crib 70 is provided in the configuration depicted in FIG. 3.

In one configuration, the inflatable pods 66 are fluidly coupled together in a manner that corresponds to zones 54. For instance, all of the inflatable pods 66 within the back zone 56 may inflate and deflate together, and can be inflated and deflated separately from the inflatable pods 66 in any of the other zones. Similarly, all of the inflatable pods 66 in the right seat zone 58a, all of the inflatable pods 66 in the left seat zone 58b, as well as all of the inflatable pods 66 in the thigh zone 60, are respectively able to be inflated and deflated together, as well as separately from the inflatable pods 66 in the other zones. Thus, the inflatable pods 66 in the back zone 56 collectively define a back bladder 74, the inflatable pods 66 in the right seat zone 58a collectively define a right seat bladder 76a, the inflatable pods 66 in the left seat zone 58b collectively define a left seat bladder 76b, and the inflatable pods 66 in the thigh zone 60 collectively define a thigh zone bladder 78. It is to be understood that the bladders 74, 76a, 76b, and/or 78 can be implemented, in alternative configurations, in manners other than pods, such as, but not limited to, elongated bladders, flat bladders, can-shaped bladders, or still other shapes.

In FIG. 4, various components of the patient support 20 are shown in the back zone 56 and the seat zone 58. The patient support 20 includes a top cover 96, a fire barrier layer 97, a layer of conductive fabric 98, the inflatable pods 66, a fabric manifold 102, a foam crib 70, a plurality of turning bladders 104, six depth sensors 94, and a bottom cover 106. The top cover 96 may be made of any conventional material used in the manufacture of hospital mattresses, such as, but not limited to, a knit polyester, and/or a polyurethane. The top cover 96 in FIG. 4 is the uppermost layer of the patient support 20—although it is to be understood that the uppermost layer may be different depending on the configuration of the patient support 20. Likewise, the fire barrier layer 97 and the conductive fabric 98 may form intermediate layers between the uppermost layer and the inflatable pods 66. An additional example of an intermediate layer is a low air loss layer that is operable to receive and distribute air for microclimate control. One or more or all of the intermediate layers may be absent in alternative configurations.

The fire barrier 97 may be positioned underneath the top cover 96 (or an uppermost layer) and may be made of any suitable material that resists the spread of fire. Such materials may vary. In one configuration, the fire barrier 97 may be made of, or include, Kevlar® (poly-paraphenylene terephthalamide), or other brands of para-aramid synthetic fibers. Other materials may alternatively be used.

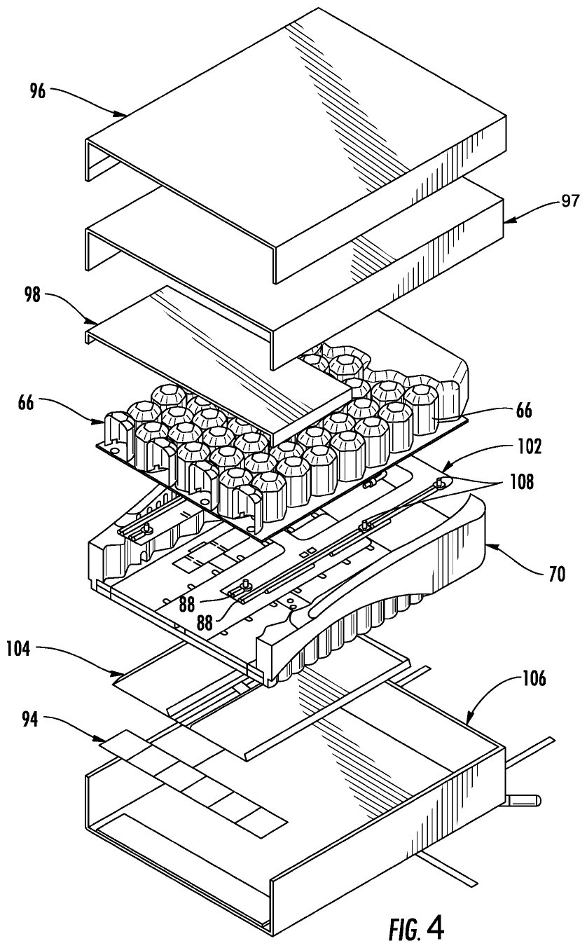

The conductive fabric 98 may operate to assist depth sensors 94 which, in the configuration shown, are capacitive sensors whose output changes as a patient moves closer or farther away from them. More specifically, the conductive fabric 98 may function in a manner similar to the top plate of a parallel plate capacitor, while the depth sensors 94 form the bottom plates of the parallel plate capacitor. Thus, as the vertical distance between the conductive fabric 98 and any of the depth sensors 94 changes, the capacitance between the fabric 98 and the depth sensors 94 will change. This change may be detected by a detector circuit 112 (FIG. 5) that is electrically coupled between the conductive fabric 98 and each of the depth sensors 94. That is, one or more wires (not shown) are electrically coupled to the conductive fabric 98 and the detector circuits 112, while one or more other wires (not shown) are connected between each depth sensor 94 and the detector circuit 112. The conductive fabric 98 may be any commercially available fabric that is electrically conductive, or it may be an electrically conductive foil, or any other material that is electrically conductive, and that is flexible enough to not significantly alter the flexibility of the patient support 20 in that region. Examples of the depth sensors 94 and circuitry associated therewith are described in further detail in U.S. Pat. No. 11,413,202 to Lefleche et al., issued Aug. 8, 2022, assigned to Stryker Corp.—the disclosure of which is hereby incorporated by reference in its entirety.

In one configuration, the top cover 96, or an intermediate layer, or a combination thereof, may include one or more sensors, such as interface sensors (depicted in FIG. 5) operable to detect an interface pressure between the patient and the patient support 20. Additionally, or alternatively, one or more sensors may be provided above the top cover 96. The interface sensors may provide sensor feedback to the pump assembly 90, which may use the sensor feedback as a basis for controlling an inflation state of the inflatable pods 66, or groups thereof.

The inflatable pods 66, as described herein, may be inflated and deflated in groups (e.g., zones 56, 58a, 58b, and 60) under the control of a pump assembly 90 and its associated control circuitry. The fluid connections between the inflatable pods 66 and the pump assembly 90 may be established by a plurality of hoses 88 that run between the pump assembly 90 and various of the inflatable pods 66. The hoses 88 are housed within the fabric manifold 102. The hoses 88 each include one or more connectors 108 for fluidly connecting the hose to one or more of the inflatable pods 66.

The pump assembly 90 may be provided within an enclosure provided proximal to the foot end 50 of the patient support 20. The pump assembly 90 may be provided beneath the foot zone 62 within an enclosure. It is to be understood that the pump assembly 90 may be configured and positioned differently depending on the application.

The pump assembly 90 may include an air pump, blower, or other source of fluid (e.g., air) that may be supplied to the hoses 88 for delivery to the inflatable pods 66. Additionally, the pump assembly 90 may be operable to remove fluid from the inflatable pods 66 via the hoses 88. In this way, with the capability to supply and remove fluid, the pump assembly 90 may selectively inflate and deflate the inflatable pods 66 in groups. In an alternative configuration, the pump assembly 90 may selectively inflate and deflate each of the inflatable pods 66, individually. As described herein, the pump assembly 90 may be operable to determine an inflation state of the inflatable pods 66 and/or groups thereof, and to direct a change in the inflation state based on at least one of sensor data and a directive from a caregiver provided via the user interface 38.

The turn bladders 104 may be positioned underneath the foam crib 70 and may be used to help turn a patient positioned on top of the patient support 20. To that end, the turn bladders 104 may extend generally longitudinally in a direction from the head end 48 to the foot end 50 and are each separately and independently inflatable and deflatable. The inflation of the turn bladders 104 may be controlled by the pump assembly 90 and its associated circuitry.

### II. Control System

FIG. 5 shows one configuration of a control system 114 that may be implemented to control the patient support 20 in the manners described herein. Other types, arrangements, and/or configurations of control systems may alternatively be used. The control system 114 may include a control system 116, a user interface 118, and a plurality of sensor systems, such as one or more of the depth sensor systems 120, a tilt sensor 124, a moisture sensor with respect to the patient support surface for detecting moisture proximal to the patent, a temperature sensor for detecting temperature proximal to the patient, an air pressure sensor 122, and interface pressure sensor 125.

The user interface 118 may be the same as user interface 38, discussed above, which is incorporated into the footboard 36 of the patient support apparatus 22, or it may be a stand-alone user interface. Such stand-alone user interfaces may include user interfaces that are incorporated into pedestals that may be removable mounted on patient beds, such as the patient support apparatus 22. In the configuration shown in FIG. 5, the user interface 118 is a touch screen. It is to be understood that other types of user interfaces may be used, including buttons, switches, knobs, lights, and/or displays.

Each depth sensor system 120 includes one of the depth sensors 94, a corresponding detector 112, the conductive fabric 98, and, in some configurations, a shield (not shown) positioned underneath the depth sensor 94. The detector 112 may be any circuitry capable of detecting the varying capacitance between the depth sensor 94 and the conductive fabric 98. In one configuration, the detector 112 may include an AD7747 capacitance-to-digital converter manufactured by Analog Devices of Norwood, Mass. Other types of detector circuitry may be used in other aspects. Whatever the circuitry used, the detectors 112 may detect the capacitance levels between depth sensor 94 and the conductive fabric 98, which provide an indication of the vertical distance between the depth sensor 94 and the conductive fabric 98, which in turn indicates how deeply a patient is currently immersed in different areas of the seat zone 58. The number and type of the depth sensor systems 120 may vary depending on the application. In FIG. 5, there are six separate detector circuits 112, thereby generating six separate measurements of patient depth in the seat zone 58. In one configuration, depth sensor systems 120 each generate capacitive measurements multiple times a second, while in other configurations, measurements are made at different frequencies.

The control system 116 may be in electrical communication with both the user interface 118 and the depth sensor systems 120, as well as a plurality of air pressure sensors 122 and, in FIG. 5, one or more tilt sensors 124. The control system 116 in one configuration may be coupled to one or more interface pressure sensors 125, which as discussed herein may be operable to detect an interface pressure between the patient and the patient support 20. Additional sensors, such as a temperature sensor or a moisture sensor, or both may be coupled to the control system 116. Additionally, or alternatively, one or more sensors described herein may be absent from the control system 116.

The air pressure sensors 122 may measure the current air pressure inside each of the inflatable bladders 66 of the patient support 20 (e.g., back bladder 74, seat bladders 76a and 76b, thigh bladder 78, and pillow bladder 79). Each of these bladders generally corresponds to zones 56, 58a, 58b, 60, and 64, respectively.

Tilt sensors 124 measure the angular orientation of one or more portions of the patient support 20, and/or they measure the entire angular orientation of the patient support 20. In some aspects, as was discussed previously, tilt sensors 124 are omitted and the patient support 20 instead receives tilt data from one or more angle sensors that are incorporated into the patient support apparatus 22. In still other aspects, the patient support 20 is implemented without any tilt sensors 124, and without receiving any tilt data from the patient support apparatus 22.

The control system 116 in FIG. 5 includes two separate circuit boards: a sensor circuit board 126 and a main control circuit board 128. The sensor circuit board 126 may receive the electrical signals from all of the various sensors and oversees the operation of these sensors (e.g., depth sensors 120, air pressure sensors 122, tilt sensors 124, interface pressure sensors 125, a temperature sensor, and a moisture sensor). The data gathered from one or more of these various sensors may be forwarded from the sensor circuit board 126 to the main control circuit board 128, and may be used as a basis for controlling a gap 68 between the patient support 20 and the patient 100 for offloading a target region of the patient 100.

In one configuration, this data from the one or more sensors may be communicated via a serial peripheral interface (SPI) bus, although it is to be understood that other buses may be used for this purpose. The main circuit board 128 may be programmed, or otherwise configured, to carry out the control algorithms described herein. Generally speaking, the main circuit board 128 may determine suitable inflation levels (e.g., a desired air pressure or—for those bladders with depth sensors 120—a desired patient depth) for all of the various bladders and controls, valves, air pump, and other aspects to implement and maintain those suitable inflation levels. More specifically, the main circuit board 128 may be in communication with an air pump control 130 and/or a plurality of deflation valves 132. By way of electrical signals sent to the pump control 130 and the deflation valves 132, the main control board 128 may be able to implement and maintain the suitable inflation levels of the various bladders. The deflation valves 132 may be configured to exhaust air from the inflatable bladders 66 to the atmosphere and/or to an air mover of the pump assembly 90 to provide a powered deflate to the inflatable bladders 66 (e.g., via a vacuum formed by the air mover with respect to an inflatable bladder 66.

As shown in FIG. 5, each board 126 and 128 includes a processor, which may be a microprocessor or a microcontroller. Indeed, each circuit board 126 and 128 may include any electrical component, or group of electrical components, that are capable of carrying out the algorithms described herein. In many configurations, the circuit boards 126 and 128 may be microprocessor-based, although not all such configurations may utilize a microprocessor. In general, the circuit boards 126 and 128 may include any one or more microprocessors, microcontrollers, field programmable gate arrays, systems on a chip, volatile or nonvolatile memory, discrete circuitry, and/or other hardware, software, or firmware that is capable of carrying out the functions described herein. Such components may be physically configured in any suitable manner, such as by mounting them to one or more circuit boards, or arranging them in other manners, whether combined into a single unit or distributed across multiple units. It is to be further understood that the control system 116 may be implemented in different forms from the two boards 126 and 128 illustrated in FIG. 5. Such variations may include combining the functions of both boards 126 and 128 onto a single board, or further distributing the functions of these boards onto more than the two boards 126 and 128 shown in FIG. 5.

### III. Pressure Redistribution

In one aspect, as described herein, one or more inflatable bladders 66 may be offloaded. Additionally, or alternatively, the pressure in one or more inflatable bladders 66 that are not offloaded may be controlled according to an active pressure redistribution methodology. Such control of the inflatable bladders 66 that are not offloaded may be utilized to substantially prevent a high pressure “ring” around an offloaded region associated with an offloaded inflatable bladder 66. An example of such an active pressure redistribution methodology is described in U.S. Pub. 2022/0378636 to Lafleche et al., entitled INFLATALE MATTRESS AND CONTROLS, published December 1, 2022—the disclosure of which is hereby incorporated by reference herein in its entirety. For instance, a suitable inflation level of one or more of the inflatable bladders 66 may be determined by monitoring the rate of change of the depth with respect to air pressure as the inflatable bladder 66 is either inflated or deflated. By detecting an inflection point in the graphical relationship of the depth and pressure outputs, a suitable inflation point for the bladders 66 may be determined that reduces interface pressures experienced by the patient, yet does not overly sink the patient into the mattress to a degree of discomfort. Active pressure redistribution may be conducted in conjunction with any inflatable bladders 66 that not currently offloaded with respect to one or more offloading aspects described herein.

### IV. Offloading

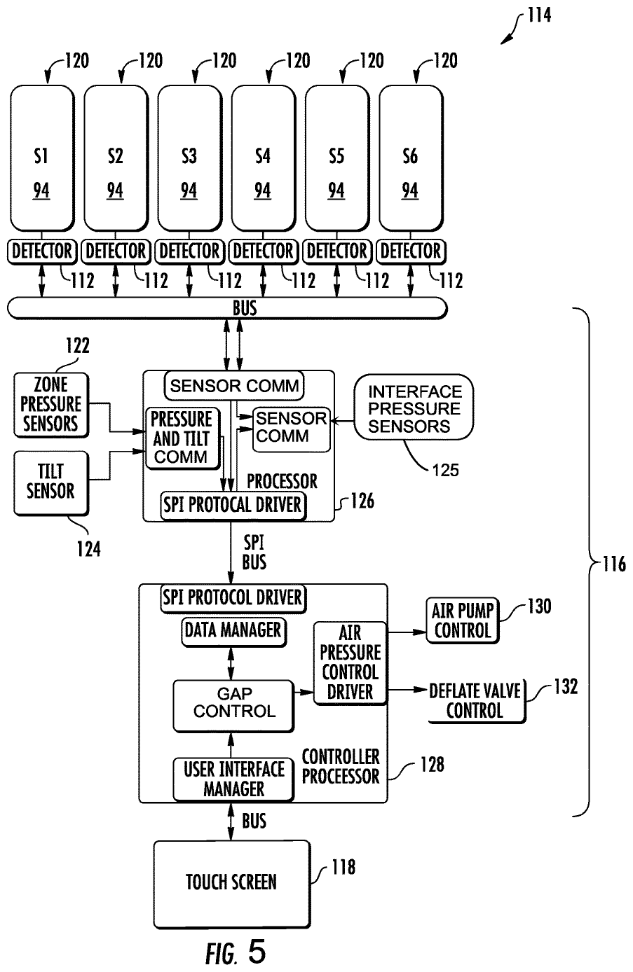

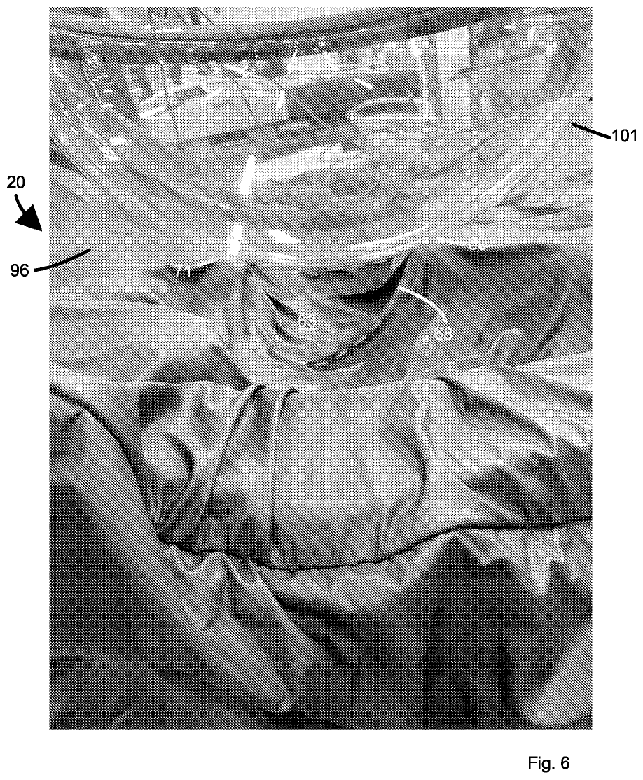

As shown in FIGS. 6-15, the patient support 20 may be configured to control operation of the plurality of inflatable bladders 66 to selectively provide a gap 68 between a patient (designated 100) and a patient support surface of the patient support 20. The gap 68 may provide offloading with respect to areas of the patient 100 to facilitate pressure injury prevention and/or pressure injury inspection. The gap 68, as described herein, may be provided by selective control over a height or an inflation level of one or more of the inflatable bladders 66, such as by deflating the one or more inflatable bladders 66 relative to others of the plurality of inflatable bladders 66. In this way, the inflation level of the plurality of inflatable bladders 66 may be controlled to selectively support some areas of the patient 100 while providing a gap for other areas between the patient support 20 and the patient 100. The gap 68 may be sufficiently large to offload pressure but sufficiently small to prevent bottoming out of the patient 100 with respect to the support deck 32. Additionally, or alternatively, the gap 68 may be sufficiently large to allow or induce ambient air access for air flow but still small enough to prevent bottoming out of the patient with respect to the support deck.

In one aspect, a region of the patient support 20 may be lowered relative to an adjacent region of the patient support 20, thereby forming the gap 68 between the patient 100 and the lowered region of the patient support 20. Lowering of the patient support 20 and resulting formation of the gap 68 may be carried out by deflating one or more of the inflatable bladders 66 relative to adjacent ones of the inflatable bladders 66. In one configuration, an inflation state of one or more of the adjacent inflatable bladders 66 may be increased, and during such inflation, prior to such inflation, or subsequent to such inflation, the inflation state of one or more inflatable bladders 66 may be decreased to form the gap 68.

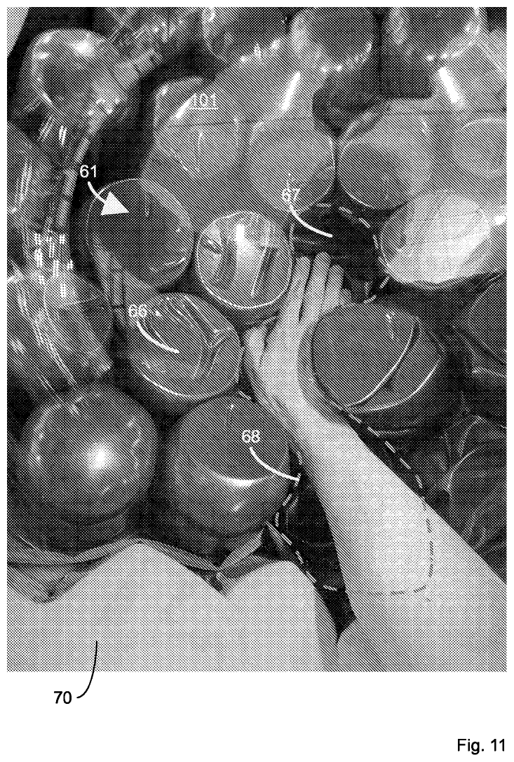

As described herein, the foam crib 70 may be absent in one or more areas or in its entirety from the patient support 20. FIGS. 9 and 11 show the gap 68 provided for the patient support 20 with the foam crib 70 provided between the gap 68 and the periphery of the patient support 20. In configurations where the foam crib 70 is absent, the gap 68 may be formed at the periphery of the patient support 20. As an example, the gap 68 may be provided at the edge or side of the patient support 20, providing access to the patient 100 through the gap 68 at the side of the patient support 20, such as to allow a caregiver to access a region of the patient 100 that is above the gap 68.

The gap 68 may facilitate avoidance of pressure injuries and/or moisture accumulation. It is noted that moisture accumulation on areas of the patient, such as the patient's sacrum, can increase the skin shear thereby increasing the risk of pressure injury development. Further pressure located at boney prominences, such as the sacrum, may affect blood capillaries potentially leading to tissue ischemia and pressure injury formation. By forming the gap 68 (e.g., by suctioning the air from a configuration of adjacent inflatable pods 66 connected to the top cover 96), ambient air can be allowed and/or induced to flow within the gap 68 between the patient support 20 and the patient 100. The gap 68 may be provided with respect to regions of the patient that may be inaccessible otherwise or accessible only in patient positions other than a current one (e.g., prone, supine, or lateral). This type of gap 68 formation may allow for the skin in these regions to dissipate heat and moisture into the ambient space to prevent moisture accumulation, thereby enhancing patient comfort and decreasing the chance of pressure injury formation.

Formation of the gap 68 may provide an offloading effect in which zero or substantially no load is applied to a region of the patient 100 (e.g., a target region or a boney prominence) corresponding to the support surface region associated with the gap 68. This approach may substantially or completely remove all pressure from the target region to redistribute the load to an adjacent area supporting the load. Use of pillows or wedges may be used conventionally in an effort to avoid contact with a target region. However, with formation of the gap 68 (or a channel configuration thereof) according to the present disclosure, the target region can be offloaded and a visual gap beneath the target region can be confirmed via absence of contact.

As described herein, the control system 116 may be operable to direct an inflation state of one or more of the plurality of inflatable bladders 66. This control may be utilized to provide a gap 68 between the patient support 20 and the patient 100. It is to be understood that the present disclosure is not limited to a plurality of inflatable bladders 66, and that any type of patient support operable to raise or lower a portion of the patient support 20 relative to a patient may be utilized and under the control of the control system 116 to form the gap 68 or variants thereof described herein.

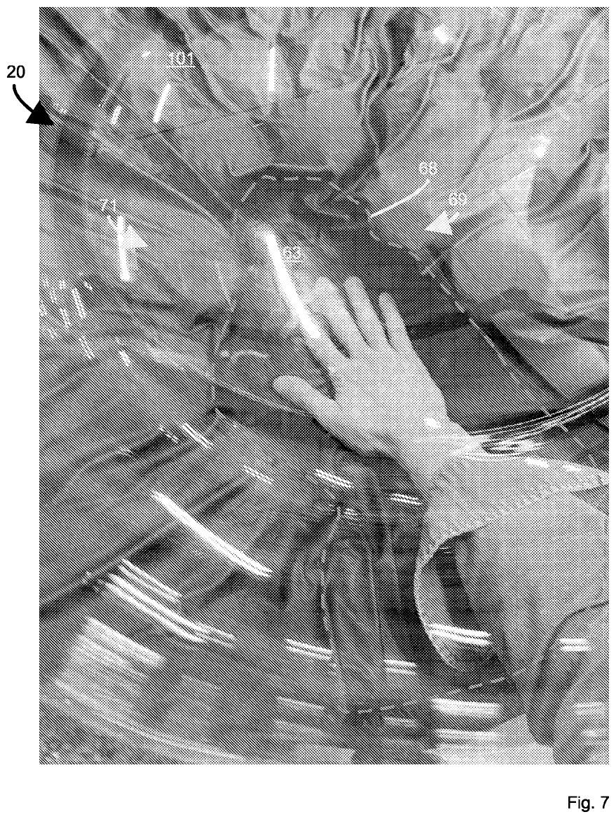

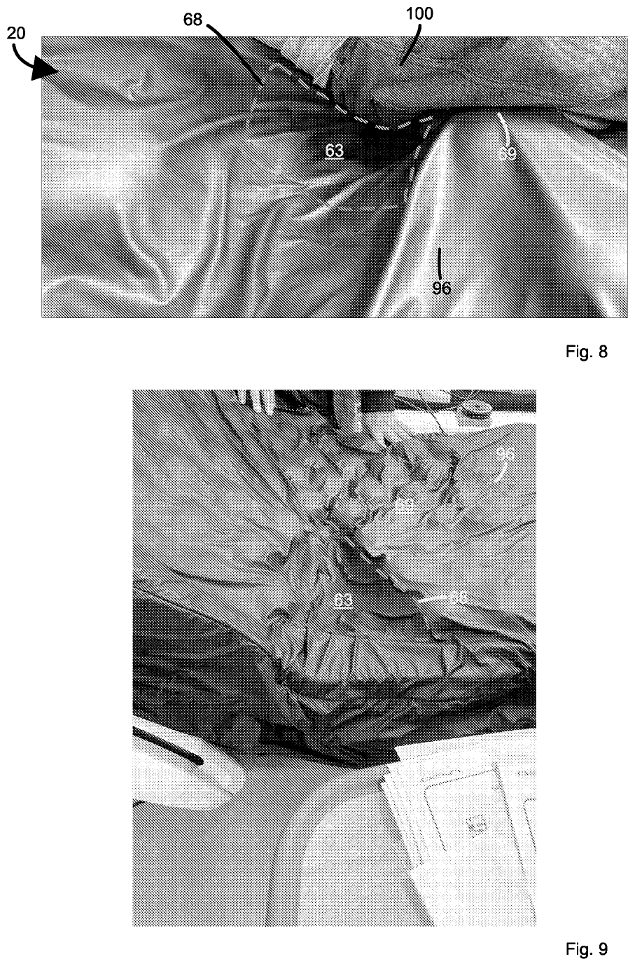

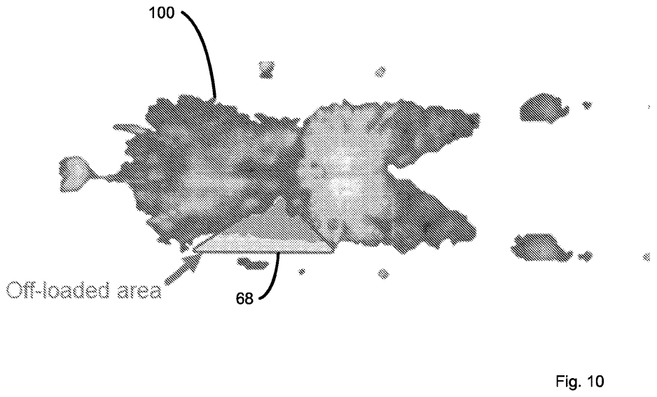

In FIGS. 6 and 7, the patient support 20 is shown with a clear window 101 for purposes of disclosure to represent a patient 100 and depict the gap 68 that can be formed between the patient support 20 and the patient 100. In place of the clear window 101 in FIGS. 6 and 7, the patient 100, the patient support 20, and the gap 68 are shown in FIG. 8. To facilitate understanding, the patient support 20 and the gap 68 are shown in FIG. 9 without the patient 100. The offloading aspect of the gap 68 can be seen in the heat map depicted in FIG. 10 showing the interface pressure for the patient 100 lying on the patient support 20 with the gap 68 shown in FIG. 8. The region of the patient 100 disposed above the gap 68 can be seen with low pressure relative to other areas of the patient 100.

In FIG. 6, the patient support 20 is operable to support the clear window 101 at a first support surface region 69 adjacent to the gap 68. The gap 68 may be associated with a second support surface region 63 that can be selectively lowered or raised relative to the patient 100 in order to respectively offload or support the patient 100 on the patient support 20. The first and second support surface regions 63, 69 may be adjacent to each other.

In one aspect, the gap 68 may provide a space in which a caretaker can visually and/or physically inspect the patient 100. For instance, in FIG. 7, the gap 68 is sufficiently large to enable a person's hand to fit within the gap 68, potentially enabling physical inspection of an associated area of the patient 100. This approach may avoid turning the patient 100 to access regions of the patient otherwise inaccessible in the patient's current position, and may be particularly helpful in cases where the patient cannot be turned due to hemodynamic instability or other complications. Turning the patient laterally in a conventional inspection or to conduct bathing procedures is considered laborious, and often involves two people to turn the patient, with one person holding the patient while the other one visually inspects and blanches from head to toe. These types of log rolling protocols to access skin regions or positioning devices beneath a patient 100 can lead to debilitating caregiver muscular skeletal injuries over time.

By dropping or lowering one or more of the inflatable bladders 66, along with an associated portion of the top cover 96 that is coupled to these one or more inflatable bladders 66, the gap 68 may be formed to provide a target inspection area. As described herein, the turn bladders 104 may be activated to pivot or tilt the patient 100 laterally to further ease visual and/or physical access to a region of the patient 100, such as the entire back including the gluteal cleft or crest thereof. This configuration may decrease the number of staff utilized for manual inspections, enhance patient stability, and decrease the potential for caregiver injury throughout the inspection process. Dropping out a support surface region associated with one or more inflatable bladders 66 (e.g., via adjusting an inflation state of the one or more inflatable bladders 66 and lowering the uppermost layer of the patient support 20 along with the one or more inflatable bladders 66) to generate the gap 68 may comply with clinical guidelines to substantially provide no contact with the sacrum and enable confirmation of the lack of contact via a physical inspection (e.g., a hand check). This configuration may substantially eliminate the need to rotate a patient laterally and insert support aides beneath the patient. A single staff member, in one configuration, can confirm that the patient 100 is in an acceptable state without exertion, thereby helping to prevent muscular skeletal strain and reducing caregiver burden.

In cases where a patient has hemodynamic instability, burns or delicate skin, or other competing priorities, a caregiver may be hesitant to perform a visual and/or physical inspection of skin regions inaccessible in the patient's current position. Controlling the patient support 20 by providing the gap 68 may enable the caregiver to overcome such hesitancy, primarily because the gap 68 may be formed without substantially affecting the patient 100. For instance, with a patient 100 maintaining a supine position and in an unstable state, providing the gap 68 may avoid causing instability due to desaturation or excessive shear leading to potential skin damage caused by periodic lateral repositioning (e.g., log rolling) with repositioning devices for inspections (e.g., Q2 turns conducted every two hours).

In one configuration, by bottoming out or dropping one or more of the inflatable bladders 66 and an adjacent top cover 96 beneath a region of the patient (e.g., the patients sacrum), the caregiver can confirm the absence of pressure beneath the target region. If the caregiver desires, he or she may also turn the patient using the turn bladders 104 which may enhance the patient's angle to observe the target region and perform a skin check. The lack of contact between the patient 100 and the patient support 20 may substantially prevent shear forces at the target area while allowing ambient air access to dissipate moisture and heat accumulation (addressing microclimate factors and enhancing patient comfort).

Controlling the patient support 20 in accordance with one configuration described herein may replace or reduce use of Q2 turns (e.g., periodic and turns for inspection) and enable offloading of patient regions (e.g., sacral offloading). The top cover 96 and intermediate layers, such as bed sheets, repositioning devices, and absorbent pads, may drop down together to maintain the gap 68. The gap 68 may be visually apparent and may facilitate inspection via cameras and probing equipment to quantify blanching for skin checks as well as tracked wound healing rates.

The control system 116, as described herein, may be operable to selectively adjust an inflation state of one or more of the plurality of inflatable bladders 66. With respect to FIGS. 6 and 9, the control system 116 is configured to deflate one or more inflatable bladders 66 associated with the second support surface region 63, and to maintain or increase an inflation state of the inflatable bladder 66 associated with the first support surface region 69. Deflation of the inflatable bladders 66 associated with the second support surface region 63 may be provided via exhausting fluid (e.g., air) to the atmosphere and/or removing fluid via an air mover. Removal of fluid from the inflatable bladders 66 associated with the second support surface region 63 via the air mover may be achieved via a vacuum applied by the air mover with respect to the inflatable bladders 66. The air mover in this configuration may be part of the pump assembly 90 described herein.

Although the first and second support surface regions 63, 69 are described in conjunction with a plurality of inflatable bladders 66, it is to be understood that one or both of the first and second support surface regions 63, 69 may be associated with a single inflatable bladder 66. It is further to be understood that one or both of the first and second support surface regions 63, 69 may be associated with a zone or a group of inflatable bladders 66 described herein.

In one aspect, a third support surface region 71 is provided in conjunction with one or more inflatable bladders 66 on a side of the second support surface region 63 that is opposite the first support surface region 69. The third support surface region 71 and the associated one or more inflatable bladders 66 may be operable to support the patient 100 similar to the first support surface region 69. With the one or more inflatable bladders 66 associated with the second support surface region 63 in a lowered state to form the gap 68, the gap 68 may take the form of a channel disposed between the first and third support surface regions 69, 71. The channel may provide or induce a fluid path for ambient air to flow between the second support surface region 63 and the patient 100, thereby enabling microclimate control over the area of the patient 100 associated with the second support surface region 63.

The top cover 96 in FIGS. 6 and 7 provides the uppermost layer with respect to the patient support 20. The top cover 96 may be operatively coupled to the plurality of the inflatable bladders 66 associated with the second support surface region 63, such that, as the inflatable bladders 66 deflate to lower relative to the adjacent inflatable bladder 66, the top cover 96 (e.g., the uppermost layer) also lowers or moves away from the patient 100 to form the gap 68 for the second support surface region 63. The top cover 96 may be coupled to the plurality of inflatable bladders 66 associated with the second support surface region 63 in a variety of ways, including but not limited to being attached directly or indirectly via intermediate layers to the top cover 96. An example of such attachment includes providing an elastic connection between the uppermost layer and the top of one or more of the inflatable bladders 66 or a layer below the inflatable bladders 66. Another example of an attachment mechanism includes providing a magnet to connect or couple the uppermost layer to the top of one or more of the inflatable bladders 66. Additionally, or alternatively, the top cover 96 may be coupled to the plurality of inflatable bladders 66 via a vacuum formed within the top cover 96 to maintain coupling between the top cover 96 and the inflatable bladders 66 regardless of an inflation level of the inflatable bladders 66. Vacuum-based coupling is not limited to a vacuum applied to the entire top cover 96—for instance, a localized vacuum or suction of air to pull the uppermost layer down may be provided rather than forming a vacuum for the entire patient support 20 and/or the top cover 96.

The top cover 96 and any intermediate layers (e.g., the fire barrier layer 97) may be sufficiently coupled to or operable to move with the inflatable bladders 66 in a variety of ways. It is further noted that the corner tightness of the top cover 96 relative to the internal components of the patient support 20 may affect the ability of the top cover 96 and any intermediate layers to operably move with the inflatable bladders 66 and facilitate formation of the gap 68. For instance, if the top cover 96 is too tight, the top cover 96 may hammock in a region associated with the gap 68, potentially affecting offloading proximal to the gap 68. On the other hand, if the top cover 96 is too loose, the top cover 96 may wrinkle or slacken in areas beneath the patient 100, potentially forming pressure points. In one configuration, the top cover 96 and any intermediate layers may be configured to sufficiently form the gap 68 while also avoiding slack and potential wrinkling when the gap 68 is absent. As an example, the top cover 96, and optionally one or more intermediate layers, may be expandable to facilitate formation of the gap 68 and to take up any slack when the gap 68 is absent. Retention mechanisms used between the top cover 96 and the inflatable bladder 66 may be configured to avoid significant textile retention that potentially causes reduction in durability and serviceability.

The top cover 96 may be coupled to the plurality of inflatable bladders 66, or a subset thereof, via a retention mechanism, such as a textile retention mechanism, to constrain multiple layers between the patient 100 and the support surface so that, when the inflatable bladder 66 drops or reduces in height, the top cover 96 and any intermediate layers fall into the gap 68 created beneath the patient 100. The gap 68 may allow previously inaccessible patient skin regions to dissipate heat and moisture via ambient air access creation. This may allow the caregiver to continue to comply with patient care needs while enhancing microclimate performance for pressure injury prevention. Conventional approaches involve products positioned between the patient and the patient support 20 in an attempt to offload regions of the patient. Formation of the gap 68 in accordance with one configuration of the present disclosure may enable avoidance of such positioning products (e.g., a pillow or wedge). Likewise, the gap 68 may overcome several deficiencies related to conventional constructions and procedures that rely on positioning products between the patient and the support surface, that utilize placement of absorbent pads (or chux) to remove and contain moisture excreted from the patient, or that use patient gowns which can adversely affect access for care activities.

Formation of the gap 68 according to one aspect of the present disclosure may be provided via deflation of one or more of the plurality of inflatable bladders 66 of the patient support 20. The one or more deflated bladders are designated 67 in FIGS. 11-13 and associated with the gap 68 shown with respect to the same. The deflated bladders 67 are depicted in FIG. 11 with the clear window 101 applying pressure to regions of the inflatable bladder 66 associated with the gap 68 and regions adjacent thereto (e.g., a plurality of inflatable bladders 61 adjacent to the deflated bladders 67). The clear window 101 is provided for purposes of understanding to show the gap 68 being sufficiently large to enable positioning of a person's hand beneath the clear window 101. In practice, the clear window 101 would be replaced with a patient 100, and the gap 68 would enable positioning of the person's hand beneath the patient 100.

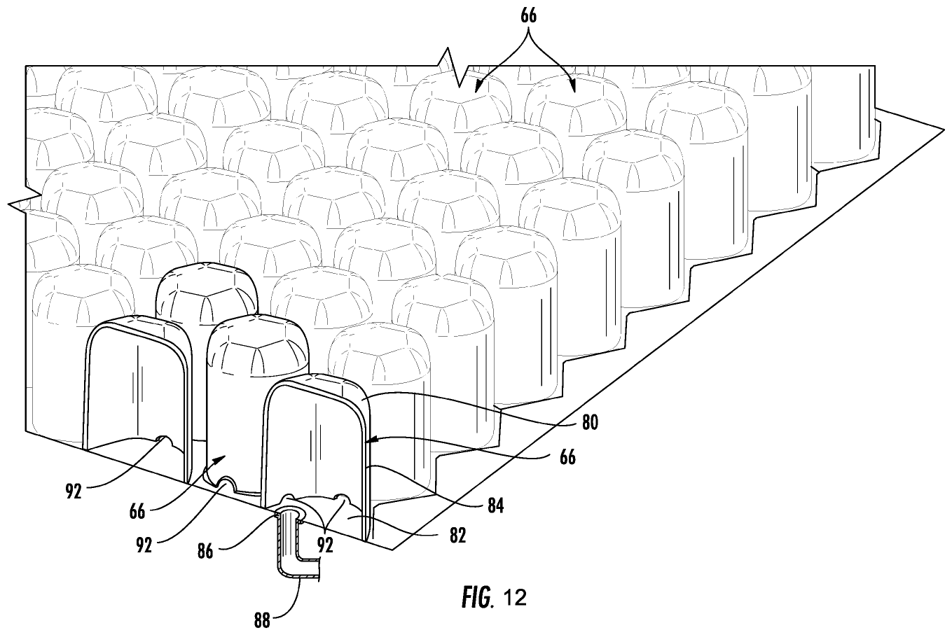

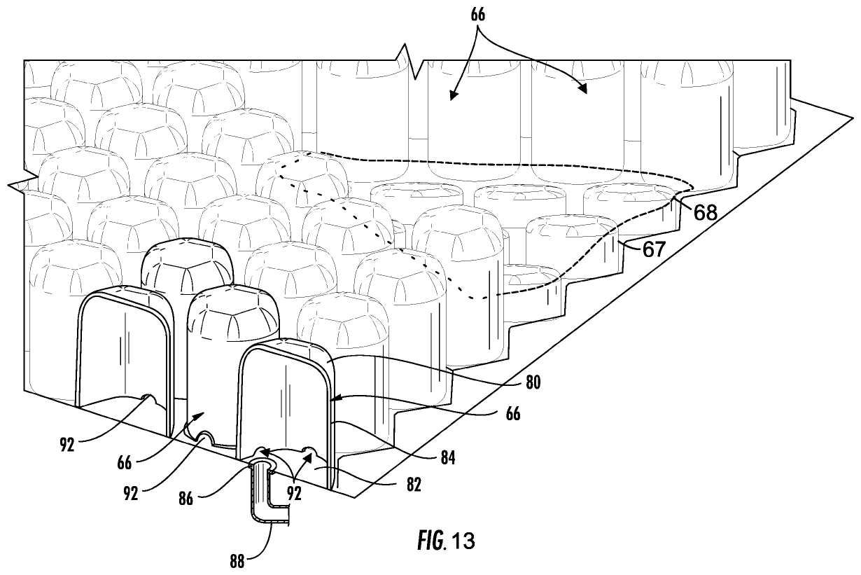

FIGS. 12 and 13 provide further detail of the inflatable pods 66 and the deflated inflatable pods 67 thereof. Each inflatable pod 66 may include a top surface 80, a base 82, and a sidewall 84. In at least one of the inflatable pods 66 in each bladder or each zone 54, an opening 86 may be defined that is adapted to be coupled to an air hose 88. The air hose 88 may extend to the pump assembly 90, which as described herein, may include an air mover for delivery or removal of air to corresponding inflatable pods 66. As can be seen in FIGS. 12 and 13, the pod 66 having an opening 86 defined in its base 82 further includes a plurality of side openings 92 defined in the sidewall 84 generally near the base 82. The side openings 92 may provide fluid communication with adjacent pods 66. Thus, air delivered via the hose 88 may be delivered not only to the pod 66 having the opening 86 defined in its base 82, but the air also may be delivered to all adjacent pods 66 that are in fluid communication with the side openings 92. Those adjacent pods may further include their own side openings 92, which may further distribute the supplied air to more pods 66. The inclusion of the side openings 92 may be arranged so that all of the inflatable pods 66 within a given zone 54 or a defined bladder are interconnected by the one or more side openings 92. The pods 66 at the edges of a zone 54 may not include side openings 92 in their exterior sides, thereby providing fluid isolation from neighboring zones. Consequently, all of the pods 66 within a given zone 54 may be in fluid communication with each other, and may generally have the same air pressure. In some configurations, more than one air hose 88 may be connected to a given zone 54, and in some configurations, separate air hoses 88 may be used for supplying air to the zone 54 and for removing air from the given zone 54. Regardless of the configuration, control over the pump assembly 90 may oversee the delivery of air to, and/or the removal of air from, the various zones 54.

For instance, the deflated bladders 67 in FIG. 13 are shown associated with the gap 68 and a zone such that each of the deflated bladders 67 are fluidly coupled to each other. In this configuration, inflation or deflation of the deflated bladders 67 via an air hose 88 may affect the inflation state of all of the inflatable bladders 66 shown as deflated bladders 67 in the illustrated zone. Alternatively, the deflated bladders 67, as well as one or more of the other inflatable bladders 66, may be individually controllable, such that the pump assembly 90 may individually control an inflation state of each of the deflated bladders 67.

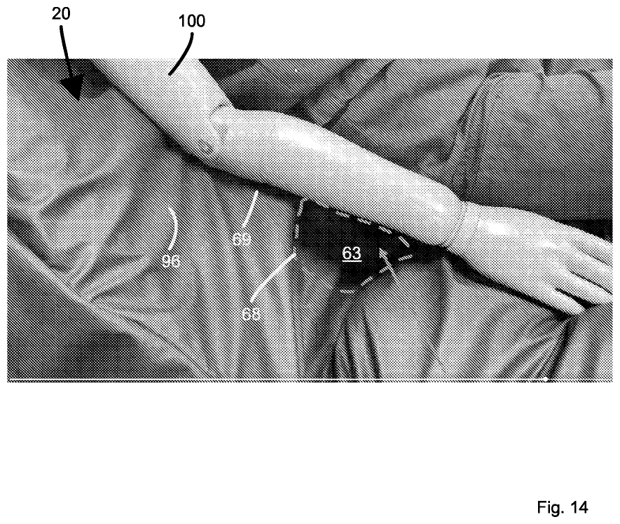

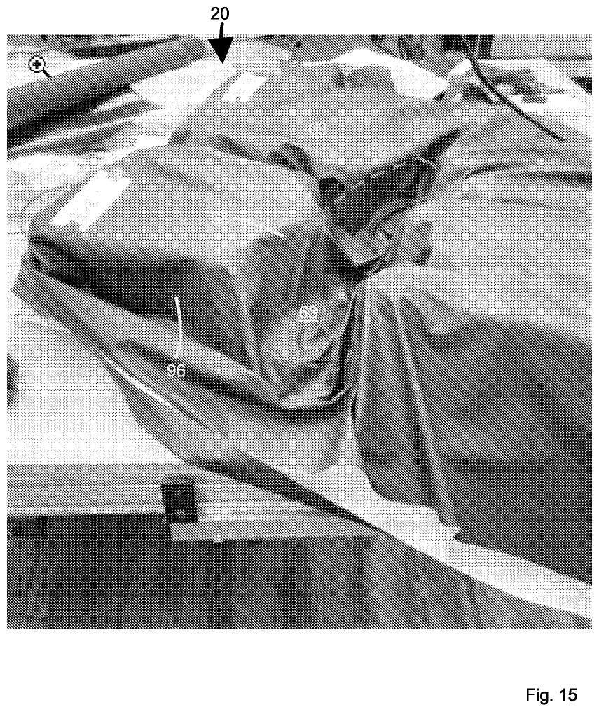

Although FIGS. 6-13 are described in conjunction with the gap 68 being in a particular location proximal to a sacral area of the patient 100, it is to be understood that the gap 68 may be formed at any location or region of the patient support 20. Likewise, it is to be understood that the gap 68 is not limited to being formed via reducing an inflation state of one or more of the inflatable bladders 66. Additional example locations include the forearm area depicted in FIG. 14 or the back area depicted in FIG. 15. Yet further examples include: supine areas, such as the shoulders, sacrum, and heels; prone areas, such as the forehead, cheeks, nose, chin, clavicle/shoulder, elbow, chest/breasts, genitalia, anterior pelvic bones, knees/patella, dorsal feet and toes; and lateral areas, such as the ear, shoulder, elbow, hip, thigh, calf, and ankle/heel.

### V. Offloading Control

As described herein, the control system 114 may control the patient support 20 in a variety of manners, specifically to control air pressure in one or more of the inflatable bladders 66 of the patient support 20. The control system 114 may control air pressure in one or more of the inflatable bladders 66 based on feedback from one or more sensors, such as an interface pressure sensor 125 that provides feedback indicative of an interface pressure between the patient and the patient support 20.

For purposes of discussion, several control methodologies for one or more inflatable bladders 66 are described herein in conjunction with selecting one or more specific inflatable bladders 66 to be offloaded. It is to be understood that such selections for offloading may be conducted with respect to one or more zones associated respectively with one or more inflatable bladders 66 so that description of selecting an inflatable bladder 66 may relate to selecting a zone associated with one or more inflatable bladders 66.

In one aspect, a caretaker may manually select one or more inflatable bladders 66 to offload various target regions of the patient 100 according to one or more aspects described herein.

As described herein, offloading adjacent pods 66 can help with creating a channel that can aid in airflow, visual access, or physical access to an area. However, in some cases, it may be helpful to prevent adjacent pods 66 from deflating at the same time. With information from a real-time pressure map (e.g., feedback from an interface pressure sensor 125), the controller 114 can know if adjacent zones are supporting a significant amount of the patient's weight. This is particularly the case in the seat area as the head angle of the bed is increased.

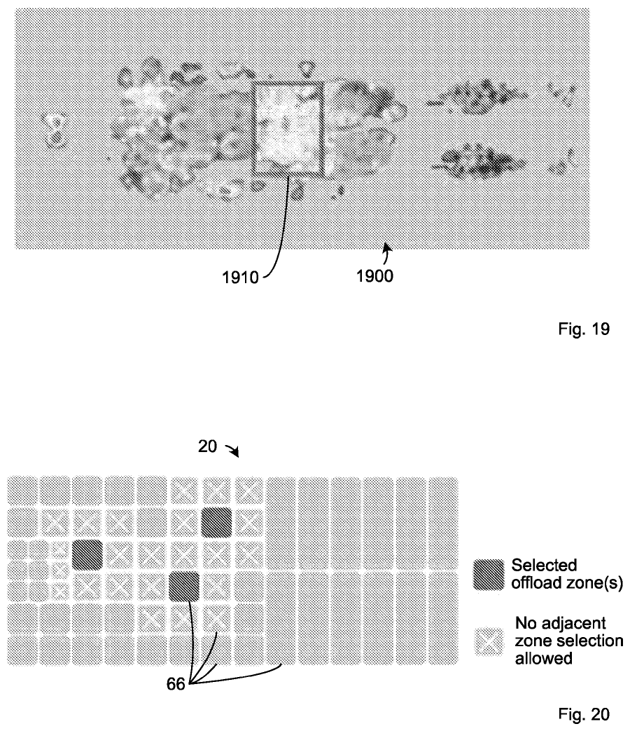

For instance, in FIG. 19, a heat map 1900 based on feedback from an interface pressure sensor 125 is shown with the seat region 1910 having increased pressure with the head of the patient support 20 being raised. In this case, control over the inflatable bladder 66 in the seat region 1910 (or any other identified region associated with the patient 100 and based on feedback from an interface pressure sensor 125) may be limited so that all or a subset of the inflatable bladder 66 in the seat region 1910 may be prevented from being offloaded at the same time. This type of control methodology may facilitate avoiding the patient 100 being bottomed out or not supported by any of the inflatable bladders 66 in an unidentified region, where such bottoming out may adversely increase the interface pressure in the identified region.

In one aspect, if an inflatable bladder 66 is offloaded relative to the patient 100, adjacent inflatable bladders 66 may be prevented from being offloaded at the same time. In FIG. 20, several inflatable bladders 66 are shown as being selected for offloading with respect to the patient 100. Adjacent inflatable bladders 66 relative to the selected inflatable bladders 66 may be disabled or excluded from selection for offloading. Such selection of inflatable bladders 66 may be conducted by a caregiver via the user interface 38, and exclusion of inflatable bladder 66 relative to the selected inflatable bladders 66 may be shown on the user interface 38 in a manner similar to that depicted in FIG. 20.

Control over the inflatable bladders 66 for selection and exclusion from offloading may be conducted in a variety of ways.

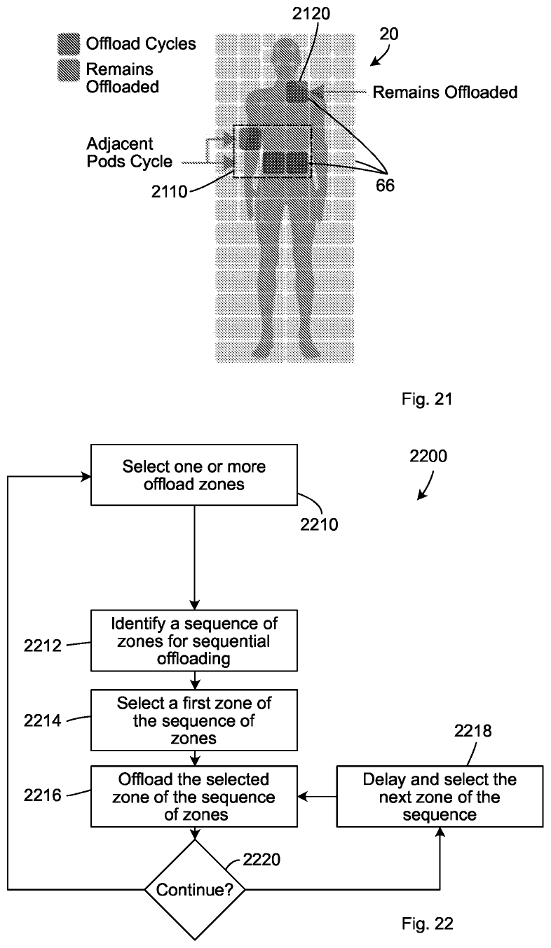

In FIGS. 21-25, the control system 114 may operate according to a method 2200 and receive a user selection (e.g., via the user interface 38) of one or more inflatable bladders 66 for offloading relative to the patient 100. Step 2210. Based on the user selection, the control system 114 may identify a sequence of inflatable pods 66 for offloading, labeled as the group 2110 in FIG. 21. Step 2212. The criteria for identifying the sequence may be inflatable pods 66 that are adjacent to each other. It is to be understood, however, that the criteria is not limited to adjacency, and any type of criteria may be utilized for identifying the sequence.

The user selection of inflatable pods 66 may include bladders 66 outside of the group 2110 identified for sequential offloading. For instance, in FIG. 21, the inflatable bladder 66 identified by the reference number 2120 may be excluded from the group 2110. This inflatable bladder 2120 may be offloaded relative to the patient 100 while the group 2120 is sequentially offloaded according to one or more aspects described herein.

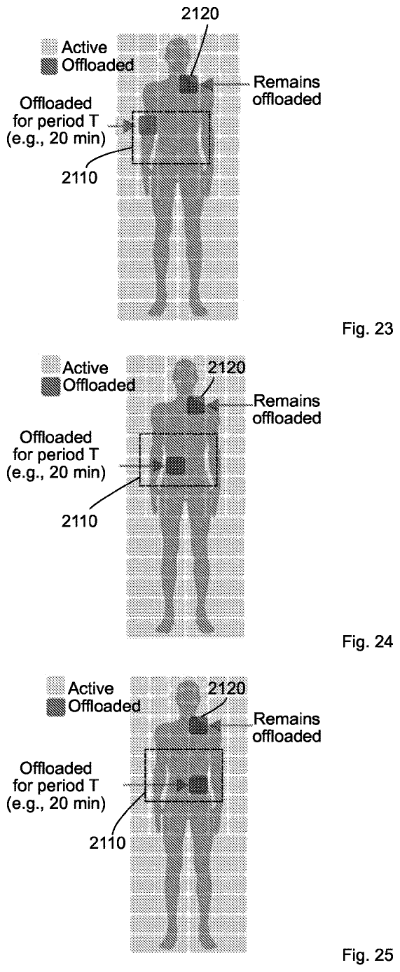

In FIGS. 22-25, the method 2200 includes selecting a first inflatable bladder 66 of the identified group 2110 of inflatable bladders 66 identified for sequential offloading and offloading the selected bladder 66 as shown in FIG. 23. Steps 2214, 2216. If operation is determined to continue, the control system 114 may select the next inflatable bladder 66 of the identified group 2110. Steps 2218, 2220. Optionally, the control system 114 may delay before or after such selection to allow the currently offloaded inflatable bladder 66 to remain offloaded for a period of time, such as 20 minutes (which may be predetermined, dynamically determined, or selected by the user). The currently offloaded inflatable bladder 66 may be re-pressurized or re-inflated, and the newly selected inflatable bladder 66 may be offloaded, as shown in FIG. 24. Step 2216. The process may continue through the identified group 2110 of inflatable bladders 66 identified for sequential offloading, with FIG. 25 showing the next inflatable bladder 66 being offloaded relative to the one offloaded in FIG. 24.

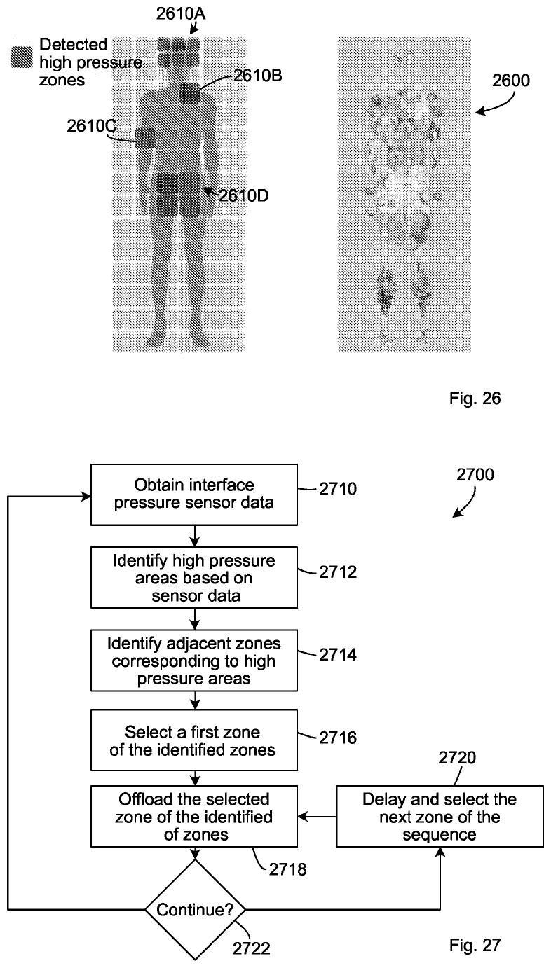

In one aspect, selection of one or more inflatable bladders 66 for offloading may be conducted based on feedback from one or more sensors, such as interface pressure feedback from the interface pressure sensor 125. For instance, the control system 114 may operate according to the method 2700 depicted in FIGS. 26-31.

The method 2700 may include obtaining sensor feedback, such as interface pressure sensor data from the interface pressure sensor 125. Step 2710. Such interface pressure sensor data can be visualized according to the heat map 2600 shown in FIG. 26. Based on the interface pressure sensor data, the control system 114 may identify one or more high pressure areas associated with the patient 100. Step 2712. For instance, in FIG. 26, the high pressure areas 2610A-D have been identified based on the heat map 2600 generated from the interface pressure sensor data obtained from the interface pressure sensor 125.

The high pressure areas 2610A-D may include regions with more than one adjacent inflatable bladders 66, and the high pressure areas 2610A-D, themselves, may be considered adjacent to each other. Based on such adjacency, the control system 114 may identify a sequence of inflatable bladders for offloading. Each stage of the sequence may include offloading one or more inflatable bladders 66, optionally within the same high pressure area 2610A-D. In one aspect, the number of stages or steps of a sequence for offloading may be reduced or optimized so that, in cases where a high pressure area 2610A-D includes multiple inflatable bladders, more than one non-adjacent inflatable bladders 66, potentially within the same high pressure area 2610A-D and/or from different high pressure areas 2610A-D, may be offloaded. This sequence determination may differ from one in which stages or steps of the sequence may involve sequentially offloading one inflatable bladder 66 at a time for a given high pressure area 2610A-D. Step 2714.

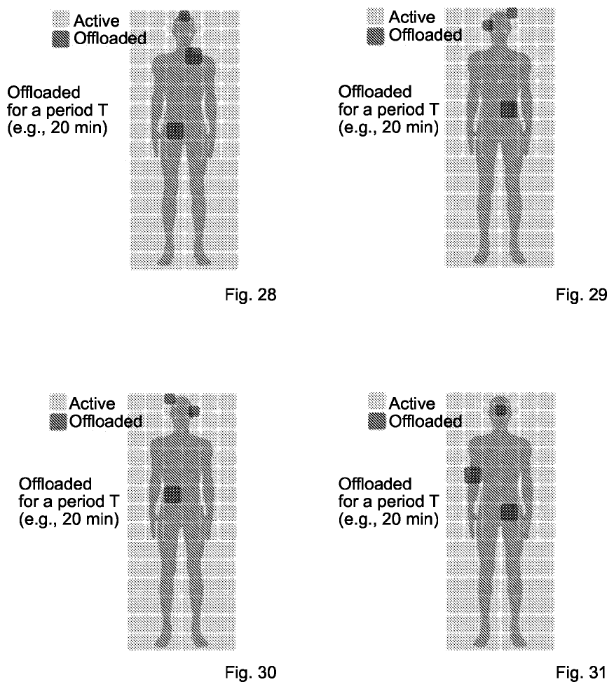

In FIGS. 27-31, the method 2700 includes selecting a first group of one or more inflatable bladders 66 identified for sequential offloading. This first group according to one aspect is depicted in FIG. 28, and the control system 114 may initiate offloading the selected group of inflatable bladders 66. Steps 2716, 2718. If operation is determined to continue, the control system 114 may select the next group of one or more inflatable bladders 66. Steps 2722, 2720. Optionally, the control system 114 may delay before or after such selection to allow the currently offloaded group of one or more inflatable bladders 66 to remain offloaded for a period of time, such as 20 minutes (which may be predetermined, dynamically determined, or selected by the user). The currently offloaded group of inflatable bladders 66 may re-pressurized or re-inflated, and the newly selected group of one or more inflatable bladders 66 may be offloaded, as shown in the progression between FIGS. 28-29. Step 2718. The process may continue through the inflatable bladders 66 associated with the high pressure areas 2610A-D and identified for sequential offloading, with FIGS. 30 and 31 showing the next steps or stages of the sequential offloading methodology.

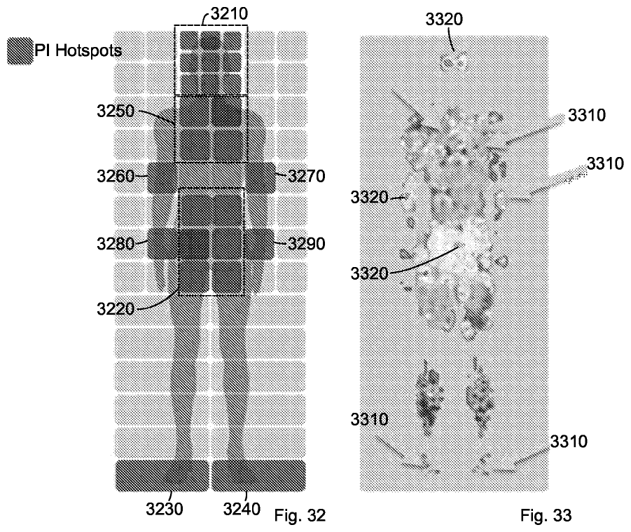

In one aspect, the control system 114 may be configured to determine a position of the patient 100 on the patient support 20 based on feedback from one or more sensors. For instance, the position of the patient 100 on the patient support may be determined based on interface pressure sensor information obtained from the interface pressure sensor 25. The determination of the position of the patient 100 may vary from application to application, such as by determining a likely location of at least a portion of the patent 100 relative to the patient support 20. As another example, the position determination may include to a silhouette of the patient 100 on the patient support 20, where the silhouette is determined based on interface pressure sensor information. Such a silhouette of the patient 100 relative to the patient support 20 is shown in FIG. 32.

Additionally, or alternatively, the position determination may include identifying how the patient 100 is laying on the patient support 20, such as whether the patient is supine, prone, or side lying.

Optionally, a caregiver may be offered an opportunity to confirm, via a user interface, the position determination of the patient 100.

As described herein, the control system 114 may control air pressure for one or more of the inflatable bladders 66 based on the position determination of the patient 100 with respect to the patient support 20. For instance, the control system 114 may selectively offload one or more of the inflatable bladders 66 based on the position determination (e.g., silhouette of the patient 100 relative to the patient support 20).

In one aspect, if the interface pressure map is known by the device or control system 113, it can map out the likely silhouette of a patient 100 and how they are laying (supine, prone, side-lying). The device or control system 114 may allow the user to confirm that it is correct. By doing so, the device or control system 114 can now locate the known pressure injury locations based on the silhouette. For example, in the supine position, the device may identify which zones correlate to the patient's head, shoulders, elbows, sacrum, trochanter, ischial tuberosity, and heels, or a combination thereof. At this point, the device or control system 114 can now offload all of those zones or a subset thereof. Counterintiutively, some of these zones may show low or medium interface pressure.

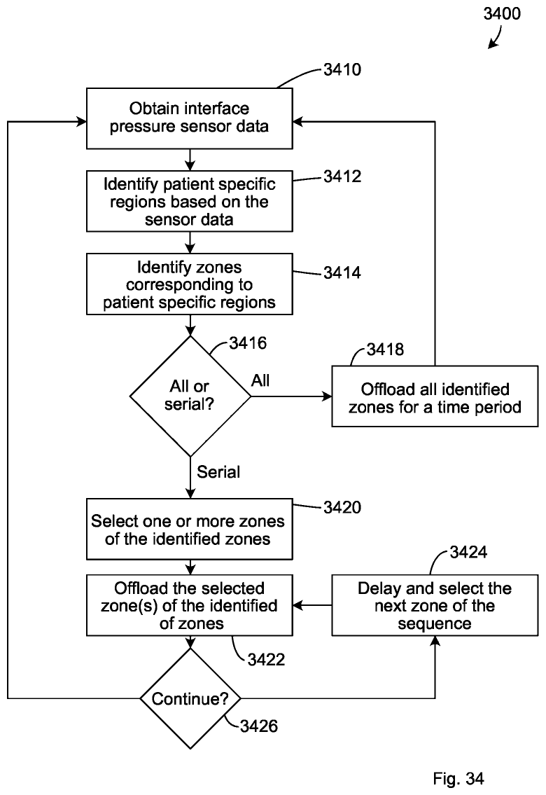

A method according to one aspect is shown in FIG. 34 and generally designated 3400. The method 3400 may include obtaining sensor feedback, such as interface pressure sensor information or data from the interface pressure sensor 125. Step 3410. Such interface pressure sensor data is shown in one aspect in the heat map in FIG. 33, with several high pressure areas being shown along with low and medium interface pressure areas.

As described herein, the controller 114 makes a position determination based on the sensor feedback, such as the pressure interface pressure sensor information or data obtained in step 3410. And, based on the position determination, the controller 114 may identify patient specific zones or regions relative to the patient support 20. Step 3412. For instance, the controller 114 may correlate to one or more specific portions of the patient 100, such as the patient's head, shoulders, elbows, sacrum, trochanter, ischial tuberosity, and heels, or a combination thereof, to the patient support 20. By identifying patient specific zones or regions, the controller 114 may locate known regions of the patient that are susceptible to injury. Such regions may or may not correspond to high pressure areas 3320 identifiable from the interface pressure sensor feedback. For instance, such regions may also correspond to low or medium pressure interface areas of the patient 100. Such low or medium pressure areas 3310 of the patient 100 are depicted in FIG. 33.

Based on the identified patient specific zones or regions, the controller 114 may identify one or more inflatable bladders 66 and/or zones of the inflatable bladder 66 of the patient support 20 that correspond to the patient specific zones or regions. Step 3414. An example of such a determination is shown in FIG. 32 with groups of inflatable bladders 66 identified by the reference numbers 3210, 3250, 3220 and specific inflatable bladders 66 identified by the reference numbers 3230, 3240, 3260, 3270, 3280, 3290. As can be seen in the comparison between FIGS. 32 and 33, the patient specific zones or regions that are low or medium pressure areas 3310 may also be associated with one or more inflatable bladders 66 or groups of inflatable bladders 66, while some areas of lower medium pressure may not be associated with one or more bladders 66.

In one aspect, because the position determination based on sensor feedback enables the controller 114 to identify patient specific zones (e.g., the head, shoulders, sacrum, heels, etc.), the controller 114 may target specific zones that it considers likely to be prone to pressure injury (potentially such specific zones may correspond high, low, or medium pressure status in the sensor feedback). Additionally, because the position determination enables correlation between the targeted patient specific zones and inflatable bladders 66 of the patient support, the controller 114 may identify inflatable bladders 66 for offloading or pressure management control. Step 3414.

The method 3400 in FIG. 34 includes determining if all or a subset of the identified inflatable bladders 66 can be offloaded. For instance, if all of the identified inflatable bladders 66 are sufficiently spaced from each other, then all of the identified inflatable bladders 66 may be offloaded at once. Steps 3416, 3418. However, if one or more identified inflatable bladders 66 are proximal or adjacent to each other, the control system 114 may determine to offload a subset of the identified inflatable bladders 66, similar to the offloading methodology described in conjunction with FIGS. 27-31. Step 3416.

The method 3400 may include selecting one or more of the identified inflatable bladders 66 from step 3414. Step 3420. The selected one or more of the selected bladders 66 may be offloaded. Step 3422. If operation is determined to continue, the control system 114 may select another group of one or more inflatable bladders 66 of the identified inflatable bladders from step 3414. Step 3424, 3426. The criteria for selection of which one or more of the identified inflatable bladders 66 from step 3414 may be similar to the criteria for selection described in conjunction with the methods 2200, 2700, including, for instance, adjacency and non-adjacency of inflatable bladders 66 relative to each other. More specifically, for instance, selection of one or more of the identified inflatable bladders 66 from step 3414 may be based on the selected inflatable bladders 66 being non-adjacent to each other, similar to the selections described in conjunction with FIGS. 28-31. Step 3424.

Optionally, the control system 114 may delay before or after such selection to allow the currently offloaded inflatable bladders 66 to remain offloaded for a period of time, such as 20 minutes (which may be predetermined, dynamically determined, or selected by the user). The currently offloaded inflatable bladders 66 may re-pressurized or re-inflated, and the newly selected inflatable bladders 66 may be offloaded. Step 3424. The process may continue through the inflatable bladders 66 identified for sequential offloading in Step 3414.

### VI. Alternating Low Pressure Therapy

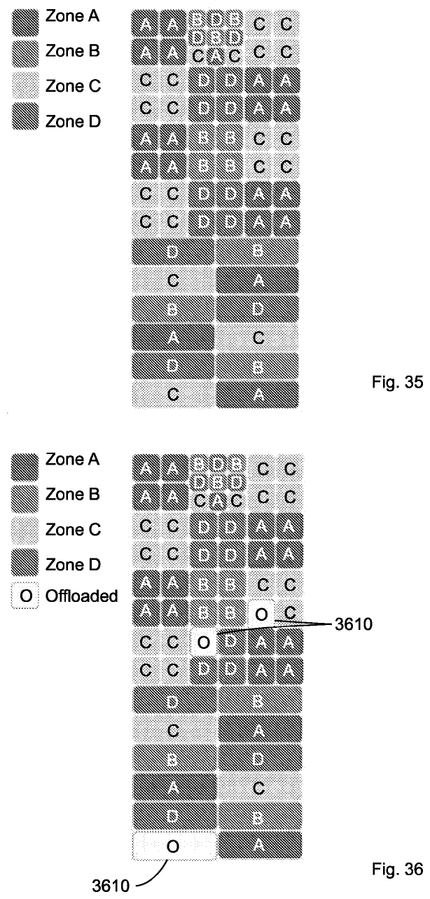

In one aspect, as described herein, one or more inflatable bladders 66 may be offloaded. Additionally, or alternatively, the pressure in the inflatable bladders 66 that are not offloaded may be controlled in conjunction with alternating low pressure therapy. Alternating low pressure therapy may be provided for powered air mattresses where bladders are assigned to two or more groupings, e.g., A and B, or A, B, and C, or A, B, C, and D. A four grouping configuration is shown in FIG. 35, with zones labeled A, B, C, and D.

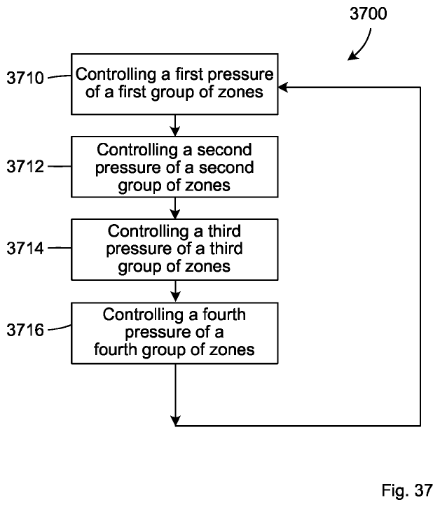

Alternating low pressure therapy in one aspect is shown in FIG. 37 in connection with the method 3700. The method 3700 may involve inflating all A bladders 66 to a low pressure and all B (and C and D) bladders 66 to a higher pressure. Step 3710. After a designated amount of time (which may be predetermined or dynamically determined), the control system 114 may direct cycling to the next sequence that involves inflating all B bladders 66 to a low pressure and all A (and C and D) bladders to a higher pressure. Step 3712. Next, for the C bladders 66, the C bladders 66 may be reduced to a low pressure and A, B, and D bladders 66 may be pressurized to a higher pressure. Step 3714. Then, for the D bladders 66, the D bladders 66 may be reduced to a low pressure and A, B, and C bladders 66 may be pressurized to a higher pressure. Step 3716. This process may repeat. It is worth noting that this alternating low pressure therapy never truly offloads pressure completely for any of the inflatable bladders 66. It is also worth noting that the process described in connection with the method 3700 is described for four groups of bladders A, B, C, and D. For fewer or greater groups of bladders 66, steps of the method 3700 may be respectively absent or included in view of the fewer number or greater number of groups of bladders 66.

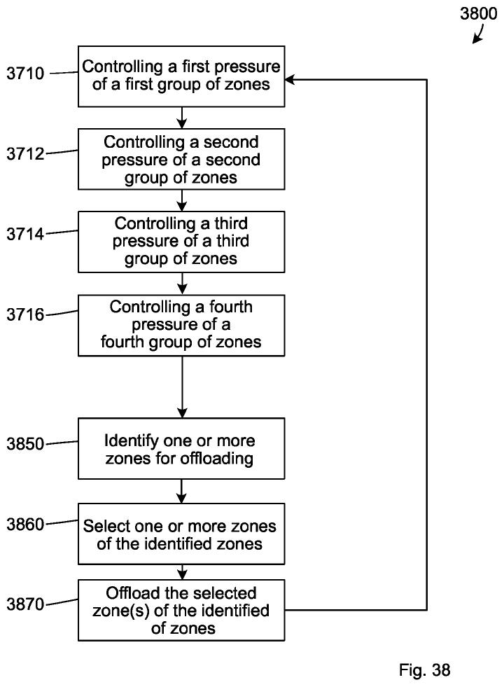

Additionally to the alternating low pressure therapy described herein, one or more of the inflatable bladders 66 may be selected for offloading according to one or more aspects described herein. For instance, the method 3700 may be incorporated into a method 3800 shown in FIG. 38, including steps 3710, 3712, 3714, and 3716. The one or more inflatable bladders 66 that are offloaded may be excluded from the alternating low pressure therapy process described in conjunction with the method 3700 (e.g., including instances of the method 3700 that include two or more groups of bladders). For instance, inflatable bladders 66 or groups of inflatable bladders 66 may be offloaded or scheduled for sequential offloading. Step 3850, 3860, 3870. Such inflatable bladders 66, while offloaded or if identified for offloading, may be excluded from the alternating low pressure therapy process. This configuration can be seen in FIG. 36, with the offloaded bladders 66 being excluded from the A, B, C, and D groups of inflatable bladders 66.

In one aspect, an inflatable bladder 66 scheduled for offloading but not currently offloaded may be grouped with and controlled with one of the groups of inflatable bladders according to alternating low pressure therapy. For instance, the inflatable bladder 3610 in FIG. 36 may be offloaded while the alternating low pressure therapy processes are conducted and therefore excluded from this process. At a later stage, when the inflatable bladder 3610 is no longer offloaded (e.g., with an adjacent inflatable bladder 66 being offloaded), the inflatable bladder 3610 may be associated with the group C bladders and controlled with the group C bladders according to the alternating low pressure therapy process.

In one aspect, the control system 114 may be configured to reconfigure or reassign inflatable bladders to different zones for alternating low pressure therapy. For instance, when an inflatable bladder 66 is scheduled for or being offloaded, adjacent bladders may be reassigned to different groups of bladders for alternating low pressure therapy. This reassignment or reconfiguration may be based on a variety of factors. For instance, reconfiguration may be based on whether a clinician designates a zone to keep offloaded because the patient has an existing pressure injury. As another example, reconfiguration may be based on whether a clinician designates a zone to not change pressure because the clinician is concerned about that part of the patient's body moving (e.g., due to a cervical collar, cast, spinal injury, etc.). In yet another example, reconfiguration may be based on whether the mattress has an algorithm that can map out the patient's silhouette and then use the zones that contact the patient, potentially only the zones that contact the patient.

### VII. Turning Operations

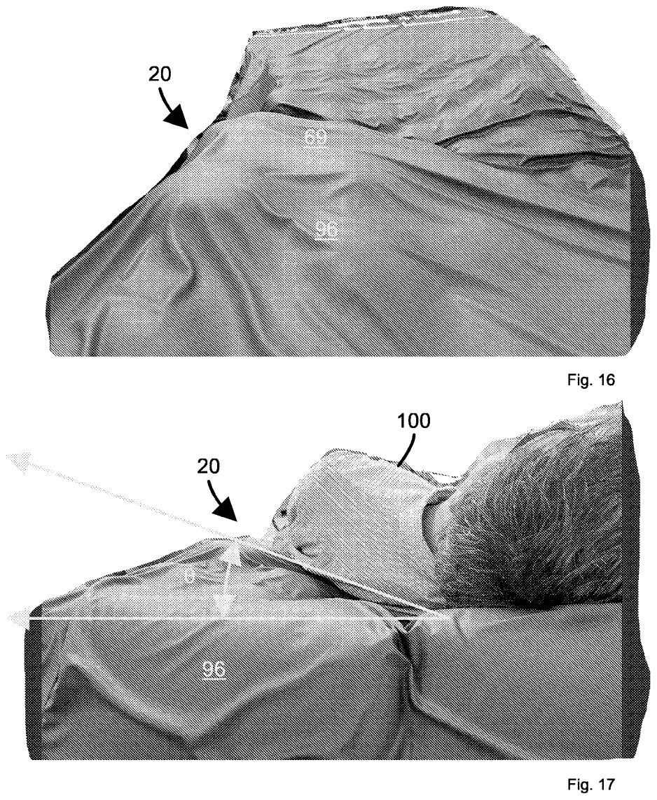

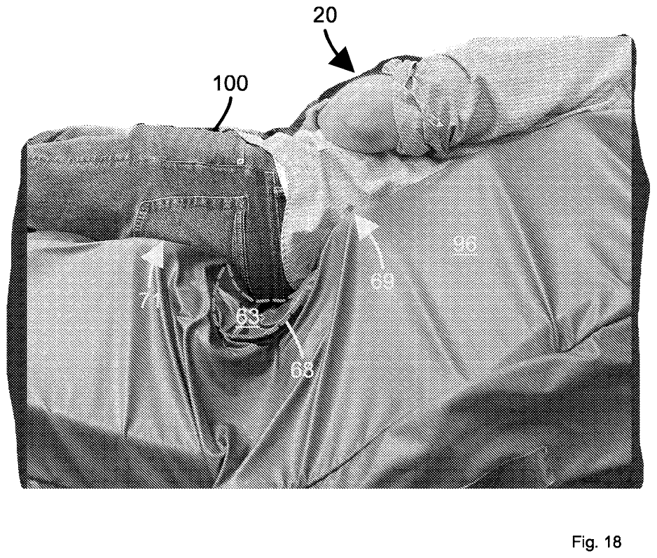

In one configuration, as described herein, the patient support 20 may include a turning mechanism, such as one or more turn bladders 104 positioned underneath the inflatable bladders 66. The turning mechanism may enable lateral pivoting of the patient 100, as depicted in FIGS. 16 and 17 with the patient 100 tilted or pivoted by an angle θ. In the case of the turning mechanism being a turn bladder 104, inflation of the left turn bladder 104 may be utilized to tilt or pivot the patient 100 by an angle θ. With the patient 100 tilted or pivoted, the control system 116 may be operable to direct formation of the gap 68 for the second support surface region 63 disposed between the first support surface region 69 and a third support surface region 71. In this way, the patient support 20 may be configured for both tilting or turning the patient 100 and offloading a region of the patient 100 via formation of the gap 68. As discussed herein, the gap 68 may be utilized to enable air flow, visible inspection, or physical inspection, or a combination thereof, with respect to the patient 100.

In one aspect, the turning mechanism may be operable to lift a lateral side of the patient relative the other lateral side of the patient, and the control system 116 may be configured to direct the turning mechanism in conjunction with lowering the height of the second support surface region 63. By lowering the height of the second support surface region 63 to form the gap 68, a caretaker can visually and or physically inspect an area of the patient 100.

### VIII. Offload History

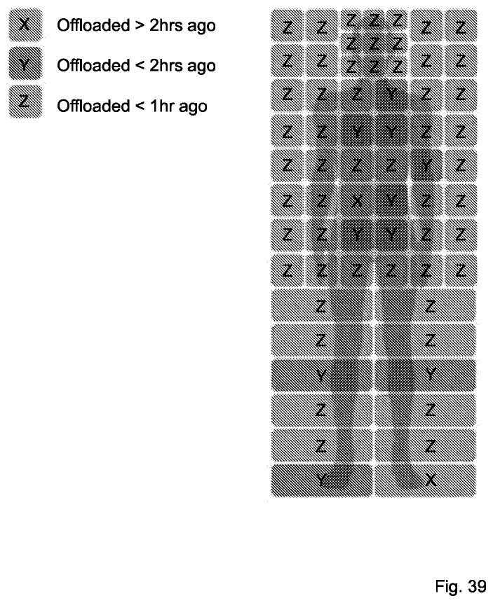

In one aspect, for each inflatable bladder 66 or for groups of inflatable bladders 66, a history of offloading can be tracked over a period of time. Such a history can be depicted on the user interface 113. The caregiver may be shown via the user interface 113 which areas of the patient support 20 have been offloaded in the recent past. The user interface 113 may show such historical information as a static image shown in FIG. 39 or a sped-up video of the interface pressure map (like a radar weather map). Based on this historical information, the controller 113 may be configured to provide a suggestions to a caregiver (e.g., via the user interface 113) relating to areas that are worth considering offloading next.

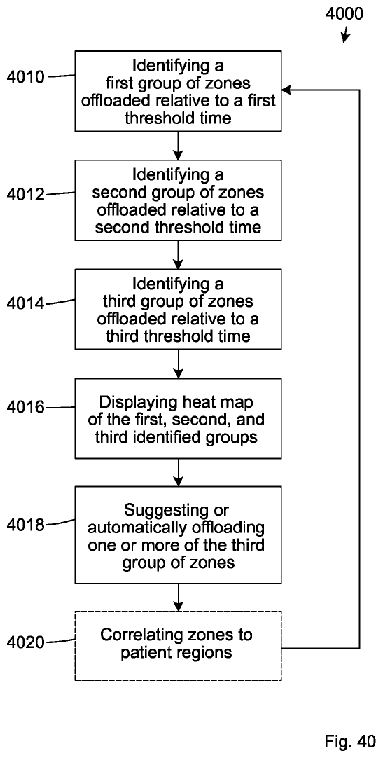

A method of tracking offload history in one aspect is shown in FIG. 40 and generally designated 4000. The method 4000 includes identifying a first group of inflatable bladders 66 that have been offloaded relative to a first threshold time, such as less than one hour ago, and a second group of inflatable bladders 66 (potentially excluding inflatable bladders identified in the first group) that have been offloaded relative to a second threshold time, such as less than two hours ago. Steps 4010, 4012. The method 4000 may also include identifying a third group of inflatable bladders 66 that have been offloaded relative to a third threshold time, such as more than two hours ago. Step 4014. A heat map may be generated relative to the first, second, and third groups of inflatable bladders 66, and this heat map may be displayed to the caregiver. Step 4016. It is to be understood that additional or fewer groups of inflatable bladders may be identified relative to threshold times.

As noted above, the method 4000 may provide a suggestion to a caregiver pertaining to the third identified group of inflatable bladders 66, such as, for example, any inflatable bladder 66 that has not been offloaded within the last two hours. Step 4018.

Optionally, the offload history may be displayed on the user interface 113 along with an indication of the position of the patient 100 relative to the inflatable bladders 66, such as by displaying a silhouette of the patient 100 relative to the plurality of inflatable bladders 66 of the patient support 20. This way, a caretaker can view the user interface 113 and visually determine, based on the heat map generated from the offload history, which areas of the patient 100 have been offloaded relative to the first, second, or third threshold times.

In one aspect, the control system 114 may track the position of the patient 100 relative to the inflatable bladder 66, such as in the case of the patient 100 migrating across the patient support 20 over time. The offload history may be tracked relative to patient specific regions rather than specific inflatable bladders 66, in one aspect. Based on this offload history for patient specific regions and the position of the patient 100 relative to the inflatable bladders 66, the heat map for the inflatable bladders 66 may correspond to offload history for each inflatable bladder 66 relative to the patient specific region associated with each inflatable bladder 66. Step 4020. For instance, once the pressure map can create a silhouette of a patient 100 and zones for offloading are selected, the offloaded areas can actually follow the patient 100 as they migrate towards the foot section of the patient support 20 or if they shift from side to side in patient support 20. Alternatively, or additionally, the caregiver may be notified if the patient has migrated more than a given distance, or if the patient's feet are close to the footboard.

Directional terms, such as “vertical,” “horizontal,” “top,” “bottom,” “upper,” “lower,” “inner,” “inwardly,” “outer” and “outwardly,” are used to assist in describing embodiments and aspects of the present disclosure based on the orientation of the embodiments and aspects shown in the illustrations. The use of directional terms should not be interpreted to limit embodiments or aspects to any specific orientation(s).

The above description is that of current embodiments and aspects of the disclosure. Various alterations and changes can be made without departing from the spirit and broader aspects of the disclosure as defined in the appended claims, which are to be interpreted in accordance with the principles of patent law including the doctrine of equivalents. This disclosure is presented for illustrative purposes and should not be interpreted as an exhaustive description of all embodiments or aspects of the disclosure or to limit the scope of the claims to the specific elements illustrated or described in connection with these embodiments or aspects. For example, and without limitation, any individual element(s) of the described embodiments or aspects may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments and aspects include a plurality of features that are described in concert and that might cooperatively provide a collection of benefits. The present disclosure is not limited to only those embodiments or aspects that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

While several forms have been shown and described, other changes and modifications will be appreciated by those skilled in the relevant art. Therefore, it will be understood that the embodiments shown in the drawings and described above are merely for illustrative purposes, and are not intended to limit the scope of the disclosure which is defined by the claims which follow as interpreted under the principles of patent law including the doctrine of equivalents.

1. A patient support system for a patient support apparatus including a deck with one or more deck sections, the patient support system comprising:
a patient support being supported on the deck and including first and second inflatable bladders, the first inflatable bladder associated with a first support surface region of the patient support, the second inflatable bladder associated with a second support surface region of the patient support, the first and second inflatable bladders adjacent to each other and operable to contact and cooperatively support a patient on the first and second support surface regions; and
a control system configured to direct an inflation level for the first and second inflatable bladders, the control system operable to reduce the inflation level of the second inflatable bladder relative to the first inflatable bladder to selectively lower the second support surface region relative to the first support surface region such that a gap is provided between the second support surface region and the patient.

2. The patient support system of claim 1 wherein a reduction in the inflation level of the second inflatable bladder is reduced by deflation of the second inflatable bladder, wherein deflation is provided by forming a vacuum with respect to the second inflatable bladder.

3. (canceled)

4. (canceled)

5. The patient support system of claim 1 wherein the patient support includes a third inflatable bladder associated with a third support surface region of the patient support, the third inflatable bladder being disposed on a side of the second inflatable bladder opposite the first inflatable bladder, wherein the control system is configured to direct an inflation level of the second inflatable bladder to selectively lower the second support surface region relative to both the first and third support surface regions to such that the gap is provided between the second support surface region and the patient and between the first and third support surface regions.

6. (canceled)

7. The patient support system of claim 5 wherein the first and third support surface regions support and contact the patient, and where the gap provides a channel between the first and third support surface regions.

8. (canceled)

9. (canceled)

10. (canceled)

11. The patient support system of claim 1 wherein the gap is sufficiently large to offload pressure but sufficiently small to prevent bottoming out of the patient with respect to the deck.

12. (canceled)

13. The patient support system of claim 1 wherein:
the patient support includes an uppermost layer provided between the first and second inflatable bladders and the patient;
the uppermost layer is operatively coupled to the second inflatable bladder and provides the second support surface region for supporting the patient thereon; and
the second support surface region of the uppermost layer lowers to provide the gap in response to a reduction in the inflation level of the second inflatable bladder relative to the first inflatable bladder.

14. (canceled)

15. (canceled)

16. The patient support system of claim 13 wherein a vacuum is formed with respect to the uppermost layer and the first and second inflatable bladders to facilitate moving the uppermost layer with the second inflatable bladder.

17. (canceled)

18. (canceled)

19. The patient support system of claim 1, comprising an interface pressure sensor provided between the patient and the first and second support surface regions, said interface pressure sensor configured to provide interface pressure sensor information pertaining to an interface pressure respectively between the patient and the first and second support surface regions, wherein the control system is configured to direct the inflation level for the first and second inflatable bladders based on the interface pressure sensor information.

20. (canceled)

21. (canceled)

22. (canceled)

23. (canceled)

24. (canceled)

25. (canceled)

26. (canceled)

27. The patient support system of claim 1, wherein the control system is configured to selectively offload the second support surface region relative to the first support surface region, while disabling the first inflatable bladder from offloading the first support surface region.

28. The patient support system of claim 27, wherein the control system is configured to sequentially offload the first and second support surface regions, wherein the control system is configured to direct the inflation level of the second inflatable bladder to offload the second support surface region relative to the patient for a first duration, and wherein the control system is configured to direct, after the first duration, the inflation level of the second inflatable bladder to support the patient on the second support surface region and to direct the inflation level of the first inflatable bladder to offload the first support surface region relative to the patient for a second duration.

29. (canceled)

30. (canceled)

31. A patient support system for a patient support apparatus including a deck with one or more deck sections, the patient support system comprising:
a patient support being supported on the deck, the patient support including a first support surface region and a second support surface region, the first and second surface regions adjacent to each other and operable to contact and cooperatively support a patient; and
a control system configured to direct a height of the first and second support surface regions, the control system operable to selectively lower the second support surface region relative to the first support surface region such that a gap is provided between the second support surface region and the patient.

32. The patient support system of claim 31 comprising:
a turning mechanism operable to lift a lateral side of the patient relative the other lateral side of the patient; and
the control system is operable to direct the turning mechanism in conjunction with lowering the height of the second support surface region.

33. The patient support system of claim 32 wherein the turning mechanism in conjunction with the lowered second support surface region enables visual and/or physical inspection of a patient area.

34. The patient support system of claim 32 wherein the control system is operable to direct the turning mechanism to lift the lateral side of the patient and to provide the gap on the lateral side to offload a region of the patient.

35. (canceled)

36. The patient support system of claim 31 wherein:
the patient support includes first and second inflatable bladders;
the first inflatable bladder is associated with the first support surface region of the patient support;
the second inflatable bladder is associated with the second support surface region of the patient support; and
the first and second inflatable bladders are adjacent to each other and operable to contact and cooperatively support the patient on the first and second support surface regions.

37. The patient support system of claim 36 wherein:
the patient support includes an uppermost layer that contacts the patient;
the uppermost layer is operatively coupled to the second inflatable bladder and provides the second support surface region for supporting the patient thereon; and
the second support surface region of the uppermost layer lowers to provide the gap in response to a reduction in an inflation level of the second inflatable bladder relative to the first inflatable bladder.

38. (canceled)

39. (canceled)

40. (canceled)

41. (canceled)

42. The patient support system of claim 36 wherein the patient support includes a third inflatable bladder associated with a third support surface region of the patient support, the third inflatable bladder being disposed on a side of the second inflatable bladder opposite the first inflatable bladder.

43. The patient support system of claim 42 wherein the control system is configured to direct an inflation level of the second inflatable bladder to selectively lower the second support surface region relative to both the first and third support surface regions to such that the gap is provided between the second support surface region and the patient and between the first and third support surface regions.

44. The patient support system of claim 43 wherein the first and third support surface regions support and contact the patient, and where the gap provides a channel between the first and third support surface regions.

45. The patient support system of claim 42 wherein the third inflatable bladder is adjacent to the second inflatable bladder such that the second inflatable bladder is sandwiched between the first and third inflatable bladders.

46. (canceled)

47. (canceled)

48. (canceled)

49. (canceled)

50. (canceled)
